(19) United States
(12) Patent Application Publication
(10) Pub. No.: US 2013/0083303 A1
(43) Pub. Date: Apr. 4, 2013

(54) Multi-Level Imaging Using Single-Pass Imaging System Having Spatial Light Modulator and Anamorphic Projection Optics

(71) Applicants: Martin E. Hoover, Rochester, NY (US); Peter Paul, Webster, NY (US); Robert P. Loce, Webster, NY (US)

(72) Inventors: Martin E. Hoover, Rochester, NY (US); Peter Paul, Webster, NY (US); Robert P. Loce, Webster, NY (US)

(73) Assignee: Palo Alto Research Center Incorporated, Palo Alto, CA (US)

(21) Appl. No.: 13/252,943

(22) Filed: Oct. 4, 2011

(51) Int. Cl. G03B 27/42

(52) U.S. Cl. 355/53

(57) ABSTRACT

An imaging system utilizes an anamorphic optical system to concentrate a two-dimensional modulated light field in a process direction such that a one-dimensional scan line image extending in a cross-process direction is generated on an imaging surface. The modulated light field is generated by directing homogeneous light onto light modulating elements arranged in a two-dimensional array. The array is configured using a scan line image data group made up of pixel image data portions. An associated group of the light modulating elements aligned in the process direction is configured by each pixel image data portion. When a pixel value is “partially on” (i.e., between “fully on” and “fully off”), the light modulating elements of the associated group are configured such that modulating elements located in the center of each group are activated, and elements located on the upper and lower ends of each group are deactivated.

### FIELD OF THE INVENTION

This invention relates to imaging systems, and in particular to single-pass imaging systems that utilize high energy light sources for high speed image transfer operations.

### BACKGROUND OF THE INVENTION

Laser imaging systems are extensively used to generate images in applications such as xerographic printing, mask and maskless lithographic patterning, laser texturing of surfaces, and laser cutting machines. Laser printers often use a raster optical scanner (ROS) that sweeps a laser perpendicular to a process direction by utilizing a polygon or galvo scanner, whereas for cutting applications laser imaging systems use flatbed x-y vector scanning.

One of the limitations of the laser ROS approach is that there are design tradeoffs between image resolution and the lateral extent of the scan line. These tradeoffs arising from optical performance limitations at the extremes of the scan line such as image field curvature. In practice, it is extremely difficult to achieve 1200 dpi resolution across a 20″ imaging swath with single galvanometers or polygon scanners. Furthermore, a single laser head motorized x-y flatbed architecture, ideal for large area coverage, is too slow for most high speed printing processes.

For this reason, monolithic light emitting diode (LED) arrays of up to 20″ in width have an imaging advantage for large width xerography. Unfortunately, present LED arrays are only capable of offering 10 milliWatt power levels per pixel and are therefore only useful for some non-thermal imaging applications such as xerography. In addition, LED bars have differential aging and performance spread. If a single LED fails it requires the entire LED bar be replaced. Many other imaging or marking applications require much higher power. For example, laser texturing, or cutting applications can require power levels in the 10W-100W range. Thus LED bars can not be used for these high power applications. Also, it is difficult to extend LEDs to higher speeds or resolutions above 1200 dpi without using two or more rows of staggered heads.

Higher power semiconductor laser arrays in the range of 100 mW-100 Watts do exist. Most often they exist in a 1D array format such as on a laser diode bar often about 1 cm in total width. Another type of high power directed light source are 2D surface emitting VCSEL arrays. However, neither of these high power laser technologies allow for the laser pitch between nearest neighbors to be compatible with 600 dpi or higher imaging resolution. In addition, neither of these technologies allow for the individual high speed control of each laser. Thus high power applications such as high power overhead projection imaging systems, often use a high power source such as a laser in combination with a spatial light modulator such as a DLP™ chip from Texas Instruments or liquid crystal arrays.

Prior art has shown that if imaging systems are arrayed side by side, they can be used to form projected images that overlap wherein the overlap can form a larger image using software to stitch together the image patterns into a seamless pattern. This has been shown in many maskless lithography systems such as those for PC board manufacturing as well as for display systems. In the past such arrayed imaging systems for high resolution applications have been arranged in such a way that they must use either two rows of imaging subsystems or use a double pass scanning configuration in order to stitch together a continuous high resolution image. This is because of physical hardware constraints on the dimensions of the optical subsystems. The double imaging row configuration can still be seamlessly stitched together using a conveyor to move the substrate in single direction but such a system requires a large amount of overhead hardware real estate and precision alignment between each imaging row.

For the maskless lithography application, the time between exposure and development of photoresist to be imaged is not critical and therefore the imaging of the photoresist along a single line does not need be exposed at once. However, sometimes the time between exposure and development is critical. For example, xerographic laser printing is based on imaging a photoreceptor by erasing charge which naturally decays over time. Thus the time between exposure and development is not time invariant. In such situations, it is desirable for the exposure system to expose a single line, or a few tightly spaced adjacent lines of high resolution of a surface at once.

In addition to xerographic printing applications, there are other marking systems where the time between exposure and development are critical. One example is the laser based variable data lithographic marking approach originally disclosed by Carley in U.S. Pat. No. No. 3,800,699 entitled, “FOUNTAIN SOLUTION IMAGE APPARATUS FOR ELECTRONIC LITHOGRAPHY”. In standard offset lithographic printing, a static imaging plate is created that has hydrophobic imaging and hydrophilic non-imaging regions. A thin layer of water based dampening solution selectively wets the plate and forms an oleophobic layer which selectively rejects oil-based inks. In variable data lithographic marking disclosed in U.S. Pat. No. 3,800,699, a laser can be used to pattern ablate the fountain solution to form variable imaging regions on the fly. For such a system, a thin layer of dampening solution also decays in thickness over time, due to natural partial pressure evaporation into the surrounding air. Thus it is also advantageous to form a single continuous high power laser imaging line pattern formed in a single imaging pass step so that the liquid dampening film thickness is the same thickness everywhere at the image forming laser ablation step. However, for most arrayed high power high resolution imaging systems, the hardware and packaging surrounding a spatial light modulator usually prevent a seamless continuous line pattern to be imaged. Furthermore, for many areas of laser imaging such as texturing, lithography, computer to plate making, large area die cutting, or thermal based printing or other novel printing applications, what is needed is laser based imaging approach with high total optical power well above the level of 1 Watt that is scalable across large process widths in excess of 20″ as well as having achievable resolution greater than 1200 dpi and allows high resolution high speed imaging in a single pass.

### SUMMARY OF THE INVENTION

The present invention is directed to high speed imaging operation in which a two-dimensional modulated light field is anamorphically imaged and concentrated to generate a substantially one-dimensional scan line image on an imaging surface (i.e., such that all pixel/dot images of the scan line image are generated simultaneously). The imaging operation utilizes an imaging system including a homogenous light source, a spatial light modulator, an anamorphic optical system, and a controller that controls the spatial light modulator in accordance with conventional image data. The spatial light modulator includes a two-dimensional array of light modulating elements that are arranged rows and columns. The homogenous light source generates a homogenous two-dimensional light field that is simultaneously directed onto all light modulating elements of the spatial light modulator. The light modulating elements are individually configured by the controller to implement one scan line image data group of the conventional image data at a time, and the configured light modulating elements are positioned to generate a two-dimensional modulated light field that is transmitted to the anamorphic optical system. That is, depending on the modulated state of each configured modulating element, the homogenous light is either passed into the modulated light field or prevented from passing into the modulated light field, thus producing a two-dimensional “field” of light and dark regions corresponding to the modulation pattern of the spatial light modulator. The anamorphic optical system images and concentrates the two-dimensional modulated light field to form the substantially one-dimensional scan line image such that it extends in a predetermined cross-process direction on the imaging surface. Because the modulated light field is generated by the spatial light modulator, whose modulating elements are configured according to the scan line image data group, the modulated light field includes a two-dimensional image of the one-dimensional scan line image that is expanded (“stretched”) in the process (e.g., vertical) direction. By utilizing the anamorphic optical system to concentrate the modulated light field in the process direction onto a substantially one-dimensional line extending in the cross-process direction, high total optical intensity (flux density) (i.e., on the order of hundreds of Watts/cm²) can be generated on any point of the scan line image without requiring a high intensity light source, thereby facilitating a reliable yet high speed imaging system that can be used, for example, to produce a one-dimensional scan line image in a single-pass high resolution high speed printing application.

In accordance with an aspect of the present invention, multi-level image exposure at lower optical resolution is utilized to achieve high quality printing by varying the exposure level at each pixel image location, as opposed to the binary imaging at higher optical resolution used in the conventional laser ROS approach. Varying exposure level per pixel in the scan line image is accomplished by controlling the number and location of the light modulating elements whose light is combined to generate each pixel image. In particular, an associated group of light modulating elements that are substantially aligned in the process direction are configured in accordance with each pixel image data portion of the scan line image data group. Each pixel image data portion includes a data value made up of several digital bits of image data corresponding to the gray-scale properties of the corresponding pixel image of the corresponding scan line image. Because the anamorphic optical system generates each pixel image of the corresponding scan line image by concentrating modulated light portions that are aligned in the process, the gray-scale properties of each pixel image can be controlled by configuring a corresponding number of modulating elements that are aligned in the process. For example, when a pixel image data portion has a fully on value, all of the modulating elements of an associated modulating element group are activated (i.e., configured into an “on” modulated state) such that homogeneous light portions directed onto all of the group's modulating elements are directed to the anamorphic optical system, thereby creating a maximum (bright) light pixel image. Similarly, when a pixel image data portion has a fully off value, all of the modulating elements of an associated modulating element group are deactivated (i.e., configured into an “off” modulated state) such that homogeneous light directed onto all of the group's modulating elements are prevented (i.e., blocked or redirected) from reaching the anamorphic optical system, thereby creating a minimum (dark) light pixel image. In contrast, when the gray-scale value of a pixel image data portion requires a pixel image that is “partially on” (i.e., between “fully on” and “fully off”), the light modulating elements of the associated group are configured such that some of the modulating elements of the associated group are activated, and some of the elements of the associated group are deactivated, thereby creating a pixel image that is brighter than a “fully off” pixel image, but darker than a “fully on” pixel image.

In accordance with a specific embodiment of the present invention, when implementing a “partially on” pixel image value, the system controller configures modulating elements of the associated group such that consecutive modulating elements located in a central region of the group are activated to contribute light to the pixel image, and modulating elements located at the upper and lower ends of the associated group are deactivated. The resulting centrally located “bright spot” provides superior contrast to the surrounding pixels, thus providing superior image generation. According to a specific embodiment, the spatial light modulator is aligned orthogonally relative to the anamorphic optical system such that the rows of the array are parallel to the cross-process direction, and the columns are aligned parallel to the process direction. With this arrangement, each of the modulating element groups entirely consists of the light modulating elements disposed in one column of the array, and the system controller configures modulating elements of each column such that a predetermined number of consecutive modulating elements located in a central region of the column are activated in accordance with the associated image pixel data value. Accordingly, different gray-scale images are achieved by activating an associated number of modulating elements disposed in the middle of each column (e.g., one-third of the modulating elements may be activated to generate a small “spot”, and two-thirds of the modulating elements may be activated to generate a slightly larger “spot”).

According to an embodiment of the present invention, the homogenous light generator includes one or more light sources and a light homogenizer optical system for homogenizing light beams generated by the light sources. For high power homogenous light applications, the light source is preferably composed of multiple lower power light sources whose light emissions are mixed together by the homogenizer optics and produce the desired high power homogenous output. According to alternative embodiments of the present invention, the light source of the homogenous light generator includes multiple low power light generating elements arranged in a row or two-dimensional array. An additional benefit of using several independent light sources is that laser speckle due to coherent interference is reduced.

The spatial light modulator utilized in the imaging operation includes a control circuit having memory cells that store image data for individually controlling the modulated state of each of light modulating elements. Depending on the data stored in its associated memory cell, which is determined by the associated pixel image data portion that is assigned to a given light modulating structure, each modulating element is adjustable between an “on” (first) modulated state and an “off” (second) modulated state in accordance with the predetermined image data. Each light modulating structure is disposed to either pass or impede/redirect the associated portions of the homogenous light according to its modulated state. When one of the modulating elements is in the “on” modulated state, the modulating structure directs its associated modulated light portion in a corresponding predetermined direction (e.g., the element passes or reflects the associated light portion toward the anamorphic optical system). Conversely, when the modulating element is in the “off” modulated state, the associated received light portion is prevented from passing to the anamorphic optical system (e.g., the light modulating structure absorbs/blocks the associated light portion, or reflects the associated light portion away from the anamorphic optical system). By modulating homogenous light in this manner prior to being anamorphically projected and concentrated, the present invention is able to produce a high power image (scan-like) line along the entire imaging region simultaneously, as compared with a rastering system that only applies high power to one point of the scan line at any given instant. In addition, because the relatively low power homogenous light is spread over the large number of modulating elements, the present invention can be produced using low-cost, commercially available spatial light modulating devices, such as digital micromirror (DMD) devices, electro-optic diffractive modulator arrays, or arrays of thermo-optic absorber elements.

According to an aspect of the present invention, the spatial light modulator and the anamorphic optical system are arranged such that modulated light received from each column of light modulating elements combine to form an associated pixel image regions (“pixel”) of the substantially one-dimensional scan line image. That is, the concentrated modulated light portion received from two or more light modulating elements in a given column (and in the “on” modulated state) are directed onto the imaging surface by the anamorphic optical system in substantially focused state, whereby the received light portions substantially overlap but are slightly offset in a vertical direction such that adjacent light portions collectively form corresponding pixel image regions of the scan line image. A key aspect of the present invention lies in understanding that the light portions passed by each light modulating element represent one sub-pixel of binary data that is delivered to the scan line by the anamorphic optical system, so that the brightness of each imaging “pixel” making up the two or more scan line images is controlled by the number of elements in the associated group/column that are in the “on” state. Accordingly, by individually controlling the multiple modulating elements disposed in each column, and by concentrating the light passed by each column onto a corresponding imaging pixel region, the present invention provides an imaging system having gray-scale capabilities using constant (non-modulated) homogenous light. According to an embodiment of the present invention, the overall anamorphic optical system includes a cross-process optical subsystem and a process-direction optical subsystem that concentrate the modulated light portions received from the spatial light modulator such that the concentrated modulated light forms the substantially one-dimensional scan line image, wherein the concentrated modulated light at the scan line image has a higher optical intensity (i.e., a higher flux density) than that of the homogenized light. By anamorphically concentrating (focusing) the two-dimensional modulated light pattern to form a high energy elongated scan line, the imaging system of the present invention outputs a higher intensity scan line. The scan line image is formed, for example, using different pairs of cylindrical or acylindrical lens that address the converging and tight focusing of the scan line image along the cross-process direction and the projection and magnification of the scan line image along the cross-process direction. In one specific embodiment, the cross-process optical subsystem includes first and second cylindrical or acylindrical lenses arranged to project and magnify the modulated light onto the elongated scan line in a cross-process direction, and the process-direction optical subsystem includes a third cylindrical or acylindrical focusing lens arranged to concentrate and demagnify the modulated light on the scan line in a direction parallel to a process direction. It should be understood that the overall optical system may have several more elements to help compensate for optical aberrations or distortions and that such optical elements may be transmissive lenses or reflective mirror lenses with multiple folding of the beam path.

According to a specific embodiment of the present invention, the spatial light modulator comprises a DLP™ chip from Texas Instruments, referred to as a Digital Light Processor in the packaged form. The semiconductor chip itself is often referred to as a Digital Micromirror Device or DMD. This DMD includes an two dimensional array of microelectromechanical (MEMs) mirror mechanisms disposed on a substrate, where each MEMs mirror mechanism includes a mirror that is movably supported between first and second tilted positions according to associated control signals generated by a control circuit. The spatial light modulator and the anamorphic optical system are positioned in a folded arrangement such that, when each mirror is in the first tilted position, the mirror reflects its associated received light portion toward the anamorphic optical system, and when the mirror is in the second tilted position, the mirror reflects the associated received light portion away from the anamorphic optical system towards a beam dump. An optional heat sink is fixedly positioned relative to the spatial light modulator to receive light portions from mirrors disposed in the second tilted position towards the beam dump. An optional frame is utilized to maintain each of the components in fixed relative position. An advantage of a reflective DMD-based imaging system is that the folded optical path arrangement facilitates a compact system footprint.

According to another specific embodiment of the present invention, homogeneous light from a light source directed onto a DMD-type spatial light modulator is directed onto an imaging drum cylinder, where a damping (fountain) solution is coated onto the outer (imaging) surface of the drum cylinder, and the concentrated modulated light from the anamorphic optical system is used to selectively evaporate the damping solution prior to passing under a ink supply structure. The DMD-type spatial light modulator is configured according to the process described above such that predetermined centrally located groups of MEMs mirror mechanisms are activated in accordance with the gray-scale value of an associated image pixel data portion during a (first) time period to generate a scan line image by removing fountain solution from an elongated surface region of the outer drum surface. When the drum cylinder subsequently rotates such that surface region has passed under ink source, ink material is disposed on exposed surface region to form an ink feature. When further rotation causes the ink feature to pass a transfer point, the adhesion between the ink material and the surface region causes transfer of the ink feature to a print medium, resulting in a “dot” in the ink printed on the print medium. Further rotation the drum cylinder moves the surface region under cleaning mechanism that removes any residual ink and fountain solution material to prepare the surface region for a subsequent exposure/print cycle.

According to alternative specific embodiments, an imaging system is utilized in which a DMD-type spatial light modulator is positioned either orthogonal to the anamorphic optical system, or is tilted slightly (e.g., by 1.8°) relative to the anamorphic optical system. In systems using the orthogonal arrangement, each group of MEMs mirror mechanisms used to implement each pixel image is entirely made up of MEMs mirror mechanisms disposed in a single column of the spatial light modulator. Conversely, in systems using the tilted arrangement, each group includes both MEMs mirror mechanisms disposed in a first column, and one or more MEMs mirror mechanisms disposed in an adjacent second column. The benefit of this tilted orientation is that imaging system produces a higher sub-pixel spatial addressable spacing and provides an opportunity to utilize software to position pixel images with fractional precision in both the cross-process and process directions.

### BRIEF DESCRIPTION OF THE DRAWINGS

These and other features, aspects and advantages of the present invention will become better understood with regard to the following description, appended claims, and accompanying drawings, where:

FIG. 1 is a top side perspective view showing a simplified imaging system utilized in accordance with an exemplary embodiment of the present invention;

FIGS. 2(A), 2(B) and 2(C) are simplified side views showing the imaging system of FIG. 1 during an imaging operation according to an embodiment of the present invention;

FIGS. 3(A) and 3(B) are simplified perspective views showing alternative light sources utilized by the homogenous light generator of the imaging system of FIG. 1 according to alternative embodiments of the present invention;

FIGS. 4(A) and 4(B) are simplified top and side views, respectively, showing a multi-lens anamorphic optical system utilized by imaging system of FIG. 1 according to a specific embodiment of the present invention;

FIG. 5 is a perspective view showing a portion of a DMD-type spatial light modulator utilized by imaging system of FIG. 1 according to a specific embodiment of the present invention;

FIG. 6 is an exploded perspective view showing a light modulating element of the DMD-type spatial light modulator of FIG. 5 in additional detail;

FIGS. 7(A), 7(B) and 7(C) are perspective views showing the light modulating element of FIG. 6 during operation;

FIG. 8 is a simplified perspective view showing a imaging system utilizing the DMD-type spatial light modulator of FIG. 5 in a folded arrangement according to a specific embodiment of the present invention;

FIG. 9 is a perspective view showing another imaging system utilizing the DMD-type spatial light modulator in the folded arrangement according to another specific embodiment of the present invention;

FIGS. 10(A), 10(B), 10(C) and 10(D) are simplified side views showing the imaging system of FIG. 9 during an imaging operation;

FIG. 11 is a simplified front view showing a DMD-type spatial light modulator configured according to another embodiment of the present invention;

FIGS. 12(A), 12(B) and 12(C) are simplified front views showing portions of an imaging surface during an imaging operation using the spatial light modulator configuration of FIG. 11; and

FIG. 13 is a simplified front view showing a DMD-type spatial light modulator configured to implement an exemplary imaging operation according to yet another embodiment of the present invention.

### DETAILED DESCRIPTION OF THE DRAWINGS

The present invention relates to improvements in imaging systems and related apparatus (e.g., scanners and printers). The following description is presented to enable one of ordinary skill in the art to make and use the invention as provided in the context of a particular application and its requirements. As used herein, directional terms such as “upper”, “uppermost”, “lower”, “vertical” and “horizontal” are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

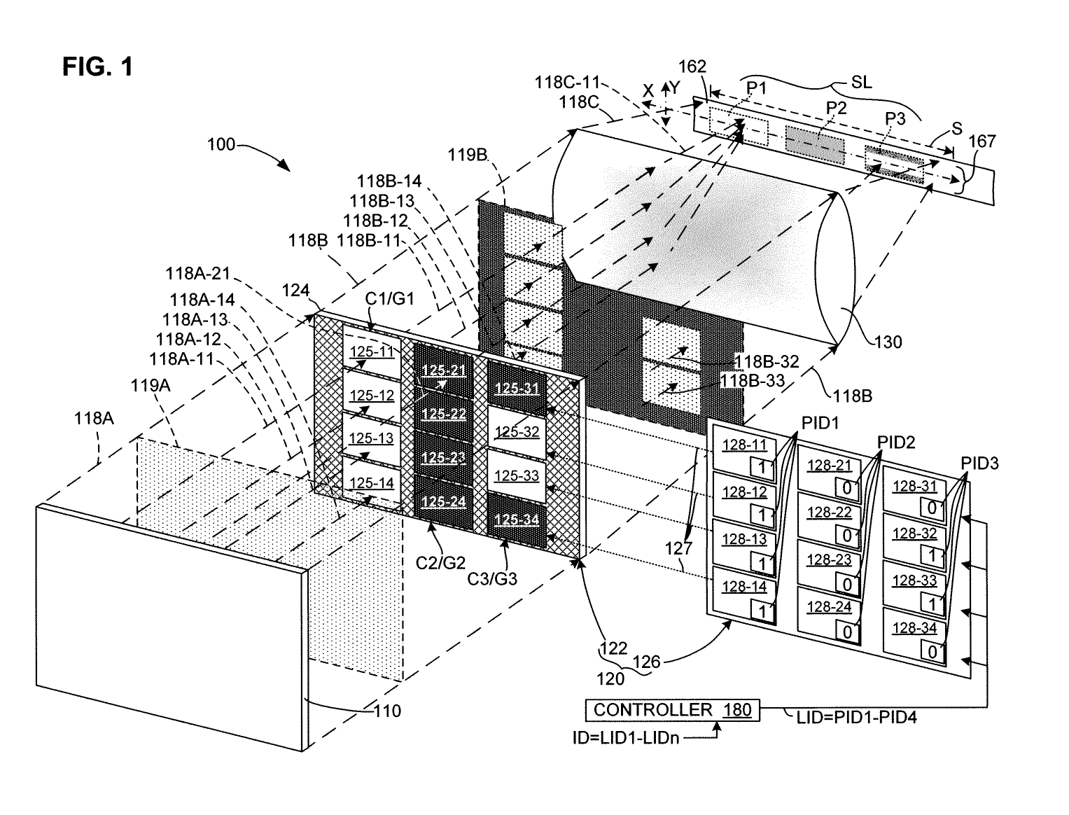

FIG. 1 is a perspective view showing a simplified single-pass imaging system 100 utilized to generate a substantially one-dimensional scan line image of a two-dimensional image on an imaging surface 162 in accordance with a simplified embodiment of the present invention. Simplified imaging system 100 generally includes a homogenous light generator 110, a spatial light modulator 120 that is controlled as described below by a controller 180 to modulate homogeneous light 118A received from homogenous light generator 110, and an anamorphic optical system 130 that images and concentrates modulated light 118B as described below to generate a scan line image SL on imaging surface 162.

The imaging process described herein involves processing digital image data corresponding to an arbitrary two-dimensional image that is stored according to known techniques and referred to herein as image data file ID. Image data file ID is depicted at the bottom of FIG. 1 being transmitted to controller 180, which processes image data file ID in the manner described below, and transmits image data file ID one line at a time to spatial light modulator 120. That is, consistent with most standardized image file formats, image data file ID is made up of multiple scan line image data groups LID1 to LIDn, where each scan line image data group includes multiple pixel image data portions that collectively form an associated one-dimensional scan line image of the two-dimensional image. For example, in the simplified example shown in FIG. 1, scan line image data group LID1 includes four pixel image data portions PID1 to PID3. Each pixel image data portion (e.g., pixel image data portion PID1) includes one or more bits of image data corresponding to the color and/or gray-scale properties of the corresponding pixel image associated with the corresponding portion of the two-dimensional image. Those skilled in the art will recognize that, in practical embodiments, each scan line image data group typically includes a much larger number of pixel image data portions that the four-, eight-, or twenty-four pixel image rows described herein.

Referring to the lower left portion of FIG. 1, homogenous light generator 110 serves to generate continuous (i.e., constant/non-modulated) homogenous light 118A that forms a substantially uniform two-dimensional homogenous light field 119A, which is depicted by the projected dotted rectangular box (i.e., homogenous light field 119A does not form a structure), is made up of homogenous light 118A having substantially the same constant energy level (i.e., substantially the same flux density).

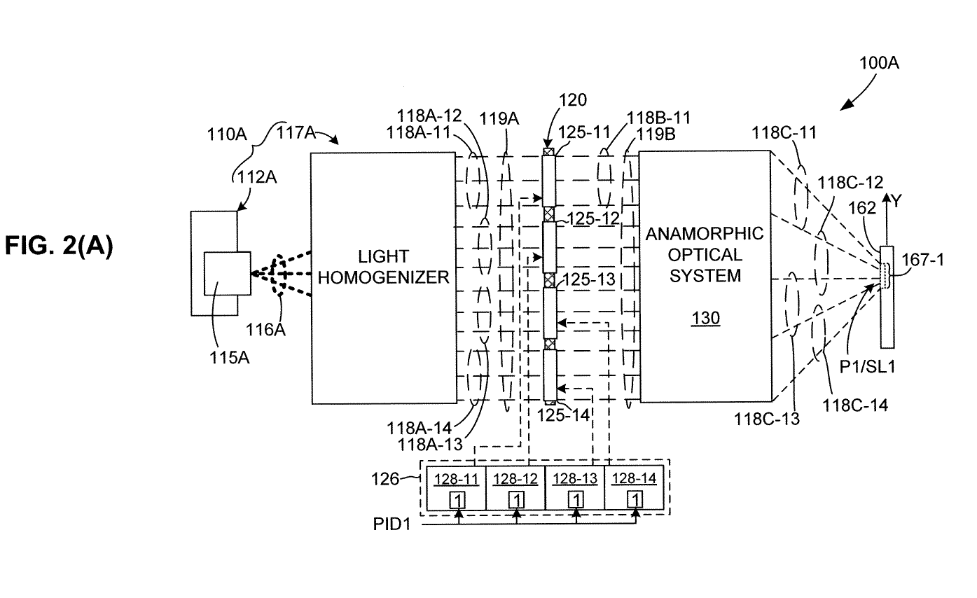

FIG. 2(A) is a simplified side view showing an imaging system 100A including a homogeneous light generator 100A according to an embodiment of the present invention. Homogenous light generator 110A includes a light source 112A including a light generating element (e.g., one or more lasers or light emitting diode) 115A fabricated or otherwise disposed on a suitable carrier (e.g., a semiconductor substrate) 111A, and a light homogenizing optical system (homogenizer) 117A. Homogenizer 117A then generates homogenous light 118A by homogenizing (i.e., mixing and spreading out light beam 116A over an extended two-dimensional area) as well as reducing any divergences of light beams 116. Those skilled in the art will recognize that this arrangement effectively coverts the concentrated, relatively high energy intensity high divergence of light beam 116A into dispersed, relatively low energy flux homogenous light 118A that is substantially evenly distributed onto all modulating elements (e.g., modulating elements 125-11 to and 125-34) of spatial light modulator 120. Note that light homogenizer 117A can be implemented using any of several different technologies and methods known in the art including but not limited to the use of a fast axis concentrator (FAC) lens together with microlens arrays for beam reshaping, or additionally a light pipe approach which causes light mixing within a waveguide.

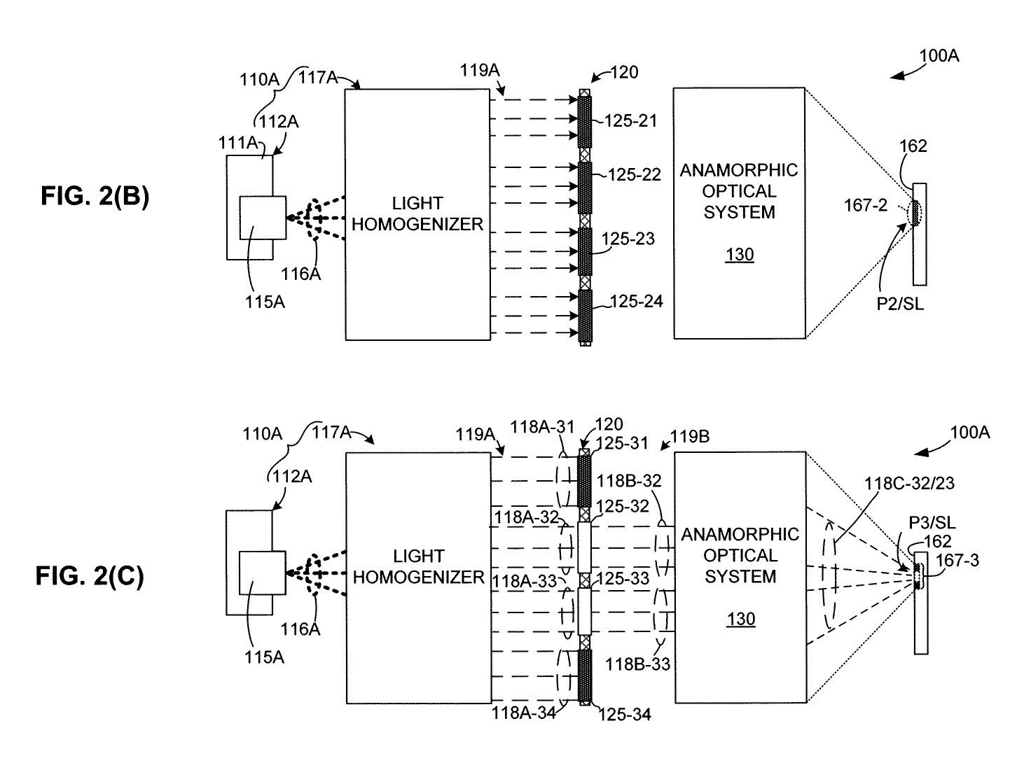

FIGS. 3(A) and 3(B) illustrate alternative light sources that may be utilized by homogeneous light source 110 of FIG. 1. FIG. 3(A) shows a light source 112B according to a specific embodiment in which multiple edge emitting laser diodes 115B are arranged along a straight line that is disposed parallel to the rows of light modulating elements (not shown). In alternative specific embodiments, light source 112B consists of an edge emitting laser diode bar or multiple diode bars stacked together. These sources do not need to be single mode and could consist of many multimode lasers. Optionally, a fast-axis collimation (FAC) microlens could be used to help collimate the output light from an edge emitting laser. FIG. 3(B) illustrates a light source 112C according to another specific embodiment in which multiple vertical cavity surface emitting lasers (VCSELs) 115C are arranged in a two-dimensional array on a carrier 111C. This two-dimensional array of VCSELS could be stacked in any arrangement such as hexagonal closed packed configurations to maximize the amount of power per unit area. Ideally such laser sources would have high plug efficiencies (e.g., greater than 50%) so that passive water cooling or forced air flow could be used to easily take away excess heat.

Referring back to the left center left portion of FIG. 1, spatial light modulator 120 is disposed in homogenous light field 119A, and includes a modulating element array 122 and a control circuit 126. Spatial light modulator 120 serves the purpose of modulating portions of homogenous light 118A in accordance with the method described below, whereby spatial light modulator 120 converts homogenous light field 119A into a two-dimensional modulated light field 119B that is projected through anamorphic optical system 130 onto an elongated imaging region 167 of imaging surface 162. In a practical embodiment such a spatial light modulator can be purchased commercially and would typically have two-dimensional (2D) array sizes of 1024×768 (SVGA resolution) or higher resolution with light modulation element (pixel) spacing on the order of 5-20 microns. For purposes of illustration, only a small subset of light modulation elements is depicted in FIG. 1.

Referring to the left-center region of FIG. 1, modulating element array 122 of spatial light modulator 120 includes modulating elements 125-11 to 125-34 that are disposed in four horizontal rows and three vertical columns C1-C3 on a support structure 124. Modulating elements 125-11 to 125-34 are disposed in homogenous light field 119A such that a light modulating structure (e.g., a mirror, a diffractive element, or a thermo-optic absorber element) of each modulating element receives a corresponding portion of homogenous light 118A (e.g., modulating elements 125-11 and 125-12 respectively receive homogenous light portions 118A-11 and 118A-12), and is positioned to selectively pass or redirect the received corresponding modulated light portion along a predetermined direction toward anamorphic optical system 130 (e.g., modulating element 125-11 allows received light portion 118A-11 to pass to anamorphic optical system 130, but modulating element 125-21 blocks/redirects/prevents received light portion 118A-21 from passing to anamorphic optical system 130).

Referring to the lower right region of FIG. 1, control circuit 126 includes an array of control (memory) cells 128-11 to 128-34 that store one scan line image data portion (e.g., scan line image data portion LIN1) during each imaging phase of an imaging operation. For example, at a given time, scan line image data portion LIN1 is transmitted (written) from controller 180 to control circuit 126 using known techniques, and scan line image data portion LIN1 is used to generate a corresponding scan line image SL in an elongated imaging region 167 of imaging surface 162. During a subsequent imaging phase (not shown), a second scan line image data portion is written into control circuit 126 (i.e., scan line image data portion LIN1 is overwritten), and a corresponding second scan line image (not shown) is generated in another elongated imaging region of imaging surface 162. Note that this process requires movement (translation) of imaging surface 162 in the process (Y-axis) direction after scan line image SL is generated and before the second scan line image is generated. Those skilled in the art will recognize that, by repeating such imaging phases for each scan image data portion LIN1-LINn of image data file ID, the associated two-dimensional image is generated on imaging surface 162.

In the exemplary embodiment shown in FIG. 1, each memory cell 128-11 to 128-34 of control circuit 126 stores a single data bit (1 or 0), and each light modulating element 125-11 to 125-34 is respectively individually controllable by way of the data bit stored in an associated memory cell 128-11 to 128-34 (e.g., by way of control signals 127) to switch between an “on” (first) modulated state and an “off” (second) modulated state. When the associated memory cell of a given modulating element stores a logic “1” value, the given modulating element is controlled to enter an “on” modulated state, whereby the modulating element is actuated to direct the given modulating element's associated received light portion toward anamorphic optic 130. For example, in the simplified example, modulating element 125-11 is turned “on” (e.g., rendered transparent) in response to the logic “1” stored in memory cell 128-11, whereby received light portion 118A-11 is passed through spatial light modulator 120 and is directed toward anamorphic optic 130. Conversely, modulating element 125-21 is turned “off” (e.g., rendered opaque) in response to the logic “0” stored in memory cell 128-21, whereby received light portion 118A-21 is blocked (prevented from passing to anamorphic optic 130). By selectively turning “on” or “off” modulating elements 125-11 to 125-34 in accordance with image data ID in the manner described herein, spatial light modulator 120 serves to modulate (i.e., pass or not pass) portions of continuous homogenous light 118A such that the modulated light is directed onto anamorphic optical system 130. As set forth in additional detail below, spatial light modulator 120 is implemented using any of several technologies, and is therefore not limited to the linear “pass through” arrangement depicted in FIG. 1.

As used herein, the portions of homogenous light 118A (e.g., homogenous light portion 118A-24) that are passed through or otherwise directed from spatial light modulator 120 toward anamorphic optic 130 are individually referred to as modulated light portions, and collectively referred to as modulated light 118B or two-dimensional modulated light field 119B. For example, after passing through light modulating element 125-11, which is turned “on”, homogenous light portion 118A-21 becomes modulated light portion 118B-11, which is passed to anamorphic optic system 130 along with light portions passed through light modulating elements 125-12, 125-13, 125-14, 125-32 and 125-33, as indicated by the light colored areas of the diagram depicting modulated light field 119B. Conversely, when a given modulating element (e.g., modulating element 125-21) is in the “off” modulated state, the modulating element is actuated to prevent (e.g., block or redirect) the given modulating element's associated received light portion, whereby the corresponding region of the diagram depicting modulated light field 119B is dark.

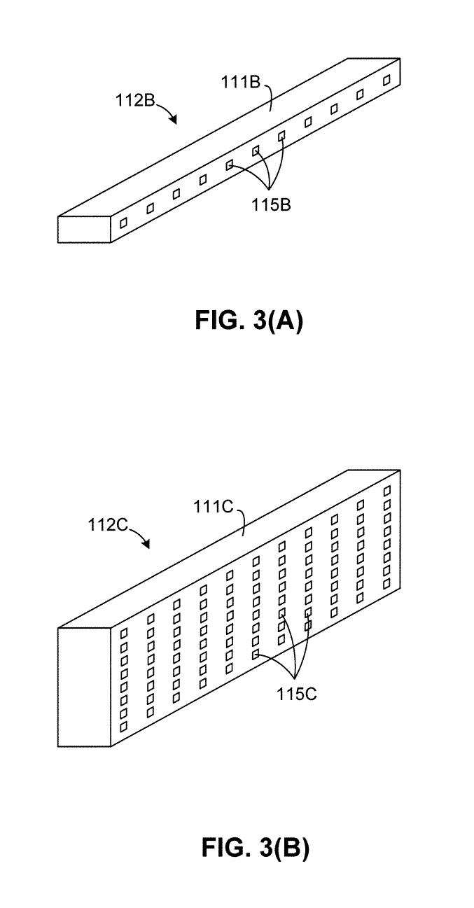

Referring to the center right portion of FIG. 1, anamorphic optical system 130 serves to anamorphically image and concentrate (focus) two-dimensional modulated light field 119B onto elongated imaging region 167 of imaging surface 162. In particular, anamorphic optical system 130 includes one or more optical elements (e.g., lenses or mirrors) that are positioned to receive the two-dimensional pattern of modulated light field 119B, where the one or more optical elements (e.g., lenses or mirrors) are arranged to concentrate the received light portions to a greater degree along the process (e.g., Y-axis) direction than along the cross-process (X-axis) direction, whereby the received light portions are anamorphically focused to form elongated scan line image SL that extends parallel to the cross-process/scan (X-axis) direction. Note that modulated light portions that have passed through anamorphic optical system 130 but have not yet reached imaging surface 162 are referred to as concentrated modulated light portions (e.g., modulated light portion 118B-11 becomes concentrated modulated light portion 118C-11 between anamorphic optical system 130 and imaging surface 162. Anamorphic system 130 is represented for the purposes of simplification in FIG. 1 by a single generalized anamorphic projection lens. In practice anamorphic system 130 is typically composed of multiple separate cylindrical or acylindrical lenses such as described below with reference to FIGS. 4(A) and 4(B), but is not limited to the generalized lens or specific lens systems described herein.

FIGS. 4(A) and 4(B) are simplified diagrams showing a portion of an imaging system 100E including a generalized anamorphic optical system 130E according to an exemplary embodiment of the present invention. Referring to FIG. 4(A), anamorphic optical system 130E includes an optional collimating optical subsystem 131E, a cross-process optical subsystem 133E, and process-direction optical subsystem 137E according to an exemplary specific embodiment of the present invention. As indicated by the ray traces in FIGS. 4(A) and 4(B), optical subsystems 131E, 133E and 137E are disposed in the optical path between spatial light modulator 120E and scan line SL, which is generated at the output of imaging system 100E. FIG. 4(A) is a top view indicating that collimating optical subsystem 131E and cross-process optical subsystem 133E act on the modulated light portions 118B passed by spatial light modulator 120E to form concentrated light portions 118C on scan line SL parallel to the X-axis (i.e., in the cross-process direction), and FIG. 4(B) is a side view that indicates how collimating optical subsystem 131E and process-direction optical subsystem 137E act on modulated light portions 118B passed by spatial light modulator 1204 and generate concentrated light portions 118C on scan line SL in a direction perpendicular to the Y-axis (i.e., in the process direction). Optional collimating optical subsystem 131E includes a collimating field lens 132E formed in accordance with known techniques that is located immediately after spatial light modulator 120E, and arranged to collimate the light portions that are slightly diverging off of the surface of the spatial light modulator 120E. Cross-process optical subsystem 133E is a two-lens cylindrical or acylindrical projection system that magnifies light in the cross-process (scan) direction (i.e., along the X-axis), and process-direction optical subsystem 137E is a cylindrical or acylindrical single focusing lens subsystem that focuses light in the process (cross-scan) direction (i.e., along the Y-axis). The advantage of this arrangement is that it allows the intensity of the light (e.g., laser) power to be concentrated on scan line SL located at the output of single-pass imaging system 100E. Two-lens cylindrical or acylindrical projection system 133E includes a first cylindrical or acylindrical lens 134E and a second cylindrical or acylindrical lens 136E that are arranged to project and magnify modulated light portions (imaging data) 118B passed by spatial light modulator 120E (and optional collimating optical subsystem 131E) onto an imaging surface (e.g., a cylinder) in the cross process direction. Lens subsystem 137E includes a third cylindrical or acylindrical lens 138E that concentrates the projected imaging data down to a narrow high resolution line image on scan line SL. As the focusing power of lens 138E is increased, the intensity of the light on spatial light modulator 120E is reduced relative to the intensity of the line image generated at scan line SL. However, this means that cylindrical or acylindrical lens 138E must be placed closer to the process surface (e.g., an imaging drum) with a clear aperture extending to the very edges of lens 138E. Additional details regarding anamorphic optical system 130E are described in co-pending application Ser. No. 13/216,976, entitled ANAMORPHIC PROJECTION OPTICAL SYSTEM, which is incorporated herein by reference in its entirety.

Referring again to FIG. 1, by utilizing anamorphic optical system 130 to concentrate modulated light field 119B in the process (Y-axis) direction, a “single-pass” substantially one-dimensional scan line image SL is formed on imaging surface 162 that extends in the cross-process (X-axis) direction. When a given pixel image (e.g., portion P1) is generated by activating all modulating elements (e.g., 125-11 to 125-14) of a given group (e.g., group G1), high total optical intensity (flux density, e.g., on the order of hundreds of Watts/cm²) is generated on a given point of scan line image SL without requiring a high intensity light source, thereby facilitating a reliable yet high speed imaging system that can be used, for example, to simultaneously produce all portions of a one-dimensional scan line image SL in a single-pass high resolution high speed printing application.

In accordance with an aspect of the present invention, multi-level image exposure capability is implemented by varying the exposure level (i.e., the amount of concentrated light) directed onto each pixel image location of scan line image SL in order to achieve high quality imaging (e.g., in a printer). In particular, the exposure level for each pixel image (e.g., portions P1, P2 and P3 in FIG. 1) in scan line image SL is varied by controlling the number and location of the activated light modulating elements of spatial light modulator 120, thereby controlling the amount and location of modulated light 118B that is combined/concentrated to generate each pixel image. This approach provides a significant improvement over conventional laser ROS operations. That is, in a high speed high resolution ROS system, it is difficult to accurately modulate the power levels of the laser to provide multi-level (gray-scale) image exposure due to the extremely short pixel times, which could be on the order of nanoseconds. By controlling the number of the activated light modulating elements in each column of spatial light modulator 120, the present invention simultaneously provides multi-level image exposure capabilities at pixel image locations of scan line image SL without having to modulate the light source. Moreover, by utilizing a homogeneous light that is spread out over an extended two-dimensional area, the intensity (Watts/cm²) of the light over a given area (e.g., over the area of each modulating element 125-11 to 125-34) is reduced to an acceptable level such that low cost optical glasses and antireflective coatings can be utilized to form spatial light modulator 120, thus reducing manufacturing costs. Uniformly spreading the light also eliminates the negative imaging effects that point defects (e.g., microscopic dust particles or scratches) have on total light transmission losses.

The multi-level image exposure capability of the present invention is achieved by forming groups of light modulating elements that are substantially aligned in the process (Y-axis) direction defined by the anamorphic optical system, and configuring each modulating element group in accordance with an associated pixel image data portion of the scan line image data group written into the spatial light modulator. For example, in the exemplary embodiment shown in FIG. 1, spatial light modulator 120 is arranged relative to anamorphic optical system 130 such that modulating element columns C1 to C3 are aligned parallel to the process (Y-axis) direction defined by anamorphic optical system 130. In this arrangement, each modulating element group consists of the modulating elements disposed in each of the columns C1 to C3, where group G1 includes all modulating element (i.e., elements 125-11 to 125-14) of column C1, group G2 includes modulating elements 125-21 to 125-24) of column C2, and group G3 includes modulating elements 125-31 to 125-34) of column C3. Because anamorphic optical system 130 generates each pixel image (e.g., pixel image P1) of scan line image SL by concentrating modulated light portions (e.g., light portions 118B-11 to 118B-14) that are aligned in the process direction, the gray-scale properties of each pixel image P1 can be controlled by configuring a corresponding number of modulating elements (e.g., elements 125-11 to 125-14) that are aligned in the process direction. By utilizing controller 180 to interpret the gray-scale value of each pixel image data portion (e.g., pixel image data portion PID1) and to write corresponding control data into control cells (e.g., cells 128-11 to 128-14) of the modulating element group (e.g., group G1) associated with that pixel image data portion, the appropriate pixel image is generated at each pixel location of scan line SL.

FIG. 1 and FIGS. 2(A) to 2(C) include simplified examples showing the multi-level image exposure of the present invention using three exposure levels: “fully on”, “fully off” and “partially on”. In the simplified example shown in FIGS. 1 and 2(A), pixel image data portion PID1 has a “fully on” (first) gray-scale value, whereby controller 180 writes pixel image data portion PID1 to control circuit 126 of spatial light modulator 120 such that all modulating elements 125-11 to 125-14 of associated modulating element group G1 are activated (i.e., configured into the “on” (first) modulated state). Because modulating elements 125-11 to 125-14 are activated, homogeneous light portions 118A-11 to 118A-14 of homogeneous light field 119A are passed through modulating elements 125-11 to 125-14 such that modulated light portions 118B-11 to 118B-14 of modulated light field 119B are directed onto the anamorphic optical system 130. These modulated light portions are then concentrated in the cross (Y-axis) direction such that concentrated light portions 118C-11 to 118C-14 generate light pixel image P1 as a maximum (bright) image “spot” in a first imaging region portion 167-1 on imaging surface 162. Similarly, as indicated in FIGS. 1 and 2(B), pixel image data portion PID2 has a “fully off” (second) value, so all of modulating elements 125-21 to 125-24 of associated modulating element group G2 are deactivated (i.e., configured into an “off” (second) modulated state) such that homogeneous light 118A (e.g., homogeneous light portions 118A-21 to 118A-24, shown in FIG. 2(A)) that directed onto modulating elements 125-21 to 125-24 are prevented (i.e., blocked or redirected) from reaching anamorphic optical system 130, thereby generating light pixel image P2 as a minimum (dark) image “spot” in a second imaging region portion 167-2 on imaging surface 162. Finally, as indicated in FIGS. 1 and 2(C), the gray-scale value of pixel image data portion PID3 is “partially on”, which requires a pixel image that is between “fully on” and “fully off”. To achieve this image level, light modulating elements 125-31 to 125-34 of associated group G3 are configured such that one or more of the modulating elements (i.e., elements 125-32 and 125-33) are activated, and one or more of the modulating elements (i.e., elements 125-31 and 125-34) are deactivated. Because modulating elements 125-32 to 125-33 are activated, homogeneous light portions 118A-32 to 118A-33 of homogeneous light field 119A are passed through modulating elements 125-32 to 125-33 such that modulated light portions 118B-32 to 118B-33 of modulated light field 119B are directed onto the anamorphic optical system 130. However, because modulating elements 125-31 and 125-34 are deactivated, homogeneous light portions 118A-31 and 118A-34 are blocked. As such, only modulated light portions 118B-32 and 118B-33 are concentrated in the cross (Y-axis) direction, whereby pixel image P3 is formed in third imaging region portion 167-3 of imaging surface 162 as a small bright “spot” formed by concentrated light portions 118C-32 to 118C-33, but otherwise has dark upper and lower regions. That is, because pixel image P3 is formed by fewer light portions than pixel image P1 but more light portions than pixel image P2, pixel image P3 that is brighter than a “fully off” pixel image, but darker than a “fully on” pixel image.

In accordance with a specific embodiment of the present invention, when implementing a “partially on” pixel image value, consecutive modulating elements located in a central region of the group are activated to contribute light to the pixel image, and modulating elements located at the upper and lower ends of the associated group are deactivated. For example, referring to FIGS. 1 and 2(C), pixel image value PID3 is implemented by activating light modulating elements 125-32 and 125-33 and deactivating modulating elements 125-31 and 125-34 of group G3, where light modulating elements 125-32 and 125-33 are consecutive elements disposed in the center of column C3, and light modulating elements 125-31 and 125-34 are respectively located at the upper and lower ends of column C3. The resulting centrally located “bright spot” provides superior contrast to the surrounding pixels, thus providing superior image generation due to the better focus and lower distortion associated with imaging light bated closer to the optical axis. As described with reference to the additional exemplary embodiments below that utilize larger arrays of modulating elements, different gray-scale image levels are achieved by activating an associated number of modulating elements disposed in the middle of each column/group (e.g., one-third of the modulating elements may be activated to generate a relatively dark exposure that leads to a relatively small “spot” in a marking process that responds to the exposure level of the “spot”, and two-thirds of the modulating elements may be activated to generate an exposure/spot that is larger/brighter than the one-third exposure/spot, but the two-thirds exposure/spot is smaller/darker than that of a “fully on” pixel image produced by turning on all of the modulating elements).

Those skilled in the art will understand that the production of a two-dimensional image using the system and method described above requires periodic or continuous movement (i.e., scrolling) of imaging surface 162 in the process (Y-axis) direction and reconfiguring spatial light modulator 120 after each imaging phase. For example, after generating scan line image SL using scan line image data group LIN1 as shown in FIG. 1, imaging surface 162 is moved upward and a second imaging phase is performed by writing a next sequential scan line image data group into spatial light modulator 120, whereby a second scan line image is generated as described above that is parallel to and positioned below scan line image SL. Note that light source 110 is optionally toggled between imaging phases, or maintained in an “on” state continuously throughout all imaging phases of the imaging operation. By repeating this process for all scan line image data groups LIN1-LINn of image data file ID, the two-dimensional image represented by image data file ID is generated on imaging surface 162.

According to alternative embodiments of the present invention, the spatial light modulator is implemented using commercially available devices including a digital micromirror device (DMD), such as a digital light processing (DLP®) chip available from Texas Instruments of Dallas TX, USA, an electro-optic diffractive modulator array such as the Linear Array Liquid Crystal Modulator available from Boulder Nonlinear Systems of Lafayette, Colo., USA, or an array of thermo-optic absorber elements such as Vanadium dioxide reflective or absorbing mirror elements. Other spatial light modulator technologies may also be used. While any of a variety of spatial light modulators may be suitable for a particular application, many print/scanning applications today require a resolution 1200 dpi and above, with high image contrast ratios over 10:1, small pixel size, and high speed line addressing over 30 kHz. Based on these specifications, the currently preferred spatial light modulator is the DLP™ chip due to its best overall performance.

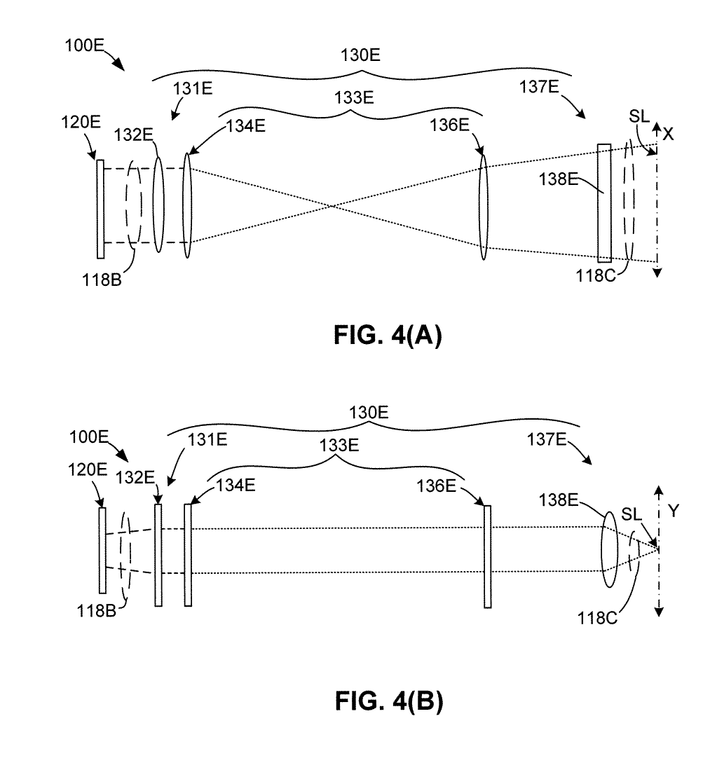

FIG. 5 is a perspective view showing a portion of a DMD-type spatial light modulator 120G including a modulating element array 122G made up of multiple microelectromechanical (MEMs) mirror mechanisms 125G. DMD-type spatial light modulator 120G is utilized in accordance with a specific embodiment of the present invention. Modulating element array 122G is consistent with DMDs sold by Texas Instruments, wherein MEMs mirror mechanisms 125G are arranged in a rectangular array on a semiconductor substrate (i.e., “chip” or support structure) 124G. Mirror mechanism 125G are controlled as described below by a control circuit 126G that also is fabricated on substrate 124G according to known semiconductor processing techniques, and is disposed below mirrors 125G. Although only sixty-four mirror mechanisms 125G are shown in FIG. 5 for illustrative purposes, those skilled in the art will understand that any number of mirror mechanisms are disposed on DMD-type modulating element array 122G, and that DMDs sold by Texas Instruments typically include several hundred thousand mirrors per device.

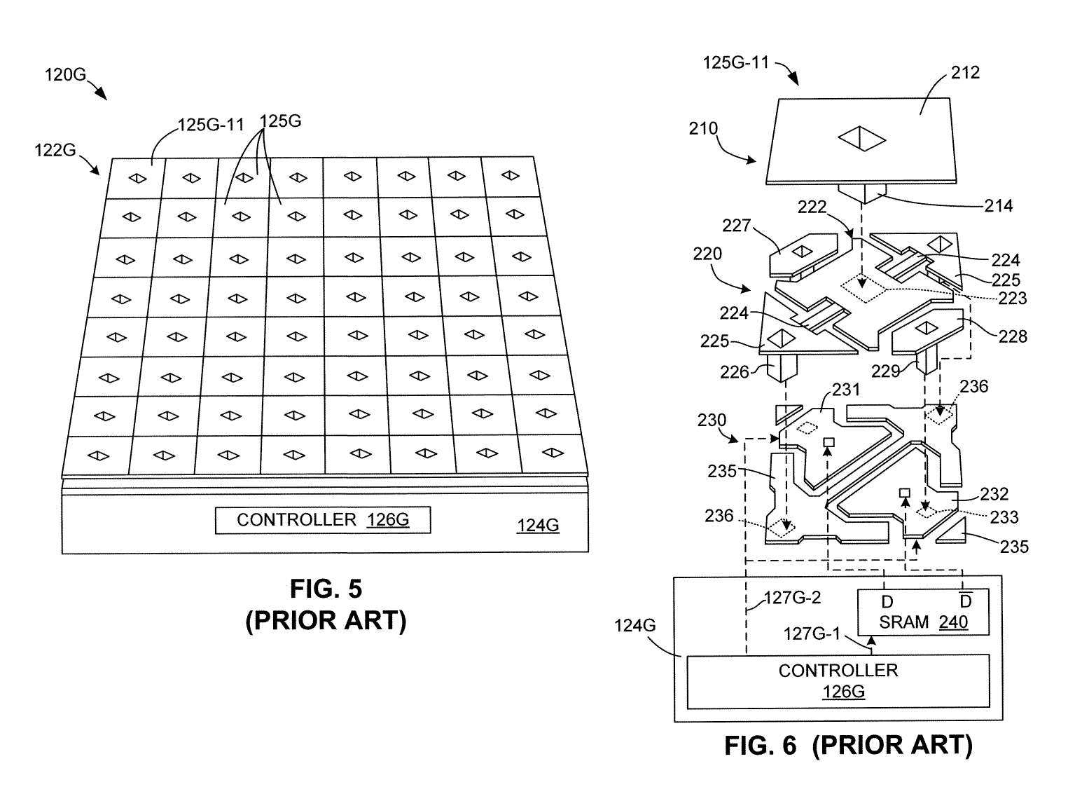

FIG. 6 is a combination exploded perspective view and simplified block diagram showing an exemplary mirror mechanism 125G-11 of DMD-type modulating element array 122G (see FIG. 5) in additional detail. For descriptive purposes, mirror mechanism 125G-11 is segmented into an uppermost layer 210, a central region 220, and a lower region 230, all of which being disposed on a passivation layer (not shown) formed on an upper surface of substrate 124G. Uppermost layer 210 of mirror mechanism 125G-11 includes a square or rectangular mirror (light modulating structure) 212 that is made out of aluminum and is typically approximately 16 micrometers across. Central region 220 includes a yoke 222 that connected by two compliant torsion hinges 224 to support plates 225, and a pair of raised electrodes 227 and 228. Lower region 230 includes first and second electrode plates 231 and 232, and a bias plate 235. In addition, mirror mechanism 125G-11 is controlled by an associated SRAM memory cell 240 (i.e., a bi-stable flip-flop) that is disposed on substrate 124G and controlled to store either of two data states by way of control signal 127G-1, which is generated by control circuit 126G in accordance with image data as described in additional detail below. Memory cell 240 generates complementary output signals D and fl-bar that are generated from the current stored state according to known techniques.

Lower region 230 is formed by etching a plating layer or otherwise forming metal pads on a passivation layer (not shown) formed on an upper surface of substrate 124G over memory cell 240. Note that electrode plates 231 and 232 are respectively connected to receive either a bias control signal 127G-2 (which is selectively transmitted from control circuit 126G in accordance with the operating scheme set forth below) or complementary data signals D and D-bar stored by memory cell 240 by way of metal vias or other conductive structures that extend through the passivation layer.

Central region 220 is disposed over lower region 230 using MEMs technology, where yoke 222 is movably (pivotably) connected and supported by support plates 225 by way of compliant torsion hinges 224, which twist as described below to facilitate tilting of yoke 222 relative to substrate 124G. Support plates 225 are disposed above and electrically connected to bias plate 235 by way of support posts 226 (one shown) that are fixedly connected onto regions 236 of bias plate 235. Electrode plates 227 and 228 are similarly disposed above and electrically connected to electrode plates 231 and 232, respectively, by way of support posts 229 (one shown) that are fixedly connected onto regions 233 of electrode plates 231 and 232. Finally, mirror 212 is fixedly connected to yoke 222 by a mirror post 214 that is attached onto a central region 223 of yoke 222.

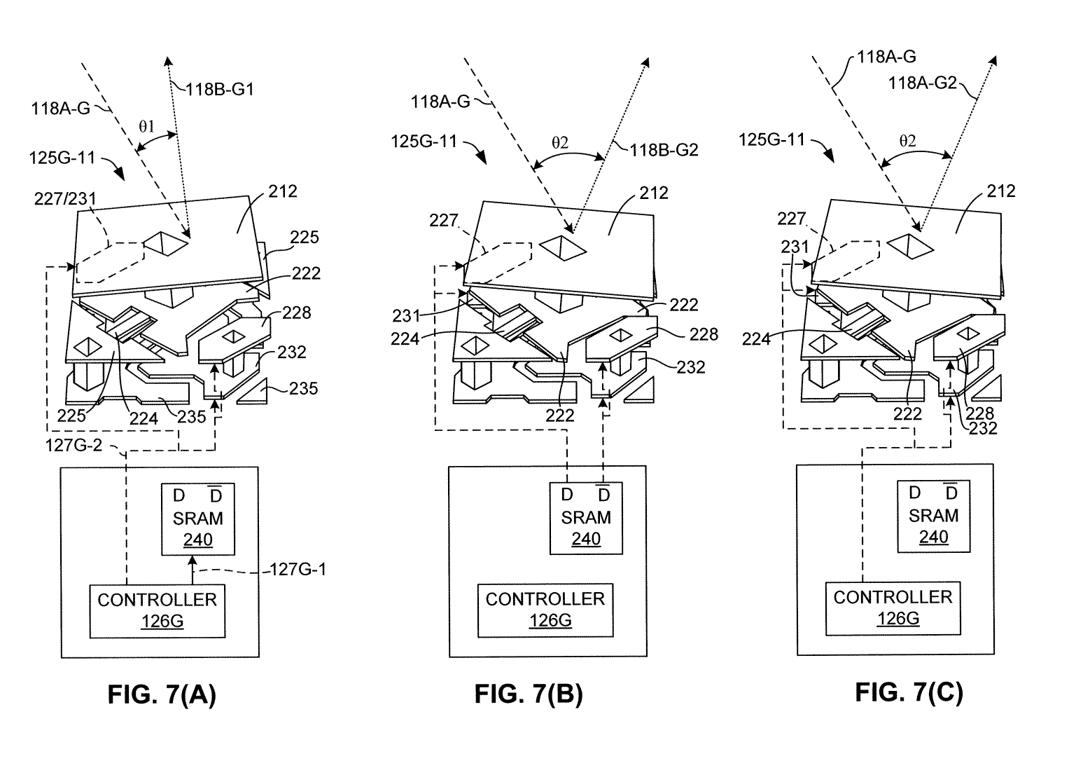

FIGS. 7(A) to 7(C) are perspective/block views showing mirror mechanism 125G-11 of FIG. 5 during operation. FIG. 7(A) shows mirror mechanism 125G-11 in a first (e.g., “on”) modulating state in which received light portion 118A-G becomes reflected (modulated) light portion 118B-G1 that leaves mirror 212 at a first angle θ1. To set the “on” modulating state, SRAM memory cell 240 stores a previously written data value such that output signal D includes a high voltage (VDD) that is transmitted to electrode plate 231 and raised electrode 227, and output signal D-bar includes a low voltage (ground) that is transmitted to electrode plate 232 and raised electrode 228. These electrodes control the position of the mirror by electrostatic attraction. The electrode pair formed by electrode plates 231 and 232 is positioned to act on yoke 222, and the electrode pair formed by raised electrodes 227 and 228 is positioned to act on mirror 212. The majority of the time, equal bias charges are applied to both sides of yoke 222 simultaneously (e.g., as indicated in FIG. 7(A), bias control signal 127G-2 is applied to both electrode plates 227 and 228 and raised electrodes 231 and 232). Instead of flipping to a central position, as one might expect, this equal bias actually holds mirror 122 in its current “on” position because the attraction force between mirror 122 and raised electrode 231/electrode plate 227 is greater (i.e., because that side is closer to the electrodes) than the attraction force between mirror 122 and raised electrode 232/electrode plate 228.

To move mirror 212 from the “on” position to the “off” position, the required image data bit is loaded into SRAM memory cell 240 by way of control signal 127G-1 (see the lower portion of FIG. 7(A). As indicated in FIG. 7(A), once all the SRAM cells of array 122G have been loaded with image data, the bias control signal is de-asserted, thereby transmitting the D signal from SRAM cell 240 to electrode plate 231 and raised electrode 227, and the D-bar from SRAM cell 240 to electrode plate 232 and raised electrode 228, thereby causing mirror 212 to move into the “off” position shown in FIG. 7(B), whereby received light portion 118A-G becomes reflected light portion 118B-G2 that leaves mirror 212 at a second angle θ2. In one embodiment, the flat upper surface of mirror 212 tilts (angularly moves) in the range of approximately 10 to 12° between the “on” state illustrated in FIG. 7(A) and the “off” state illustrated in FIG. 7(B). When bias control signal 127G-2 is subsequently restored, as indicated in FIG. 7(C), mirror 212 is maintained in the “off” position, and the next required movement can be loaded into memory cell 240. This bias system is used because it reduces the voltage levels required to address the mirrors such that they can be driven directly from the SRAM cells, and also because the bias voltage can be removed at the same time for the whole chip, so every mirror moves at the same instant.

As indicated in FIGS. 7(A) to 7(C), the rotation torsional axis of mirror mechanism 125G-11 causes mirrors 212 to rotate about a diagonal axis relative to the x-y coordinates of the DLP chip housing. This diagonal tilting requires that the incident light portions received from the spatial light modulator in an imaging system be projected onto each mirror mechanism 125G at a compound incident angle so that the exit angle of the light is perpendicular to the surface of the DLP chip. This requirement complicates the side by side placement of imaging systems.

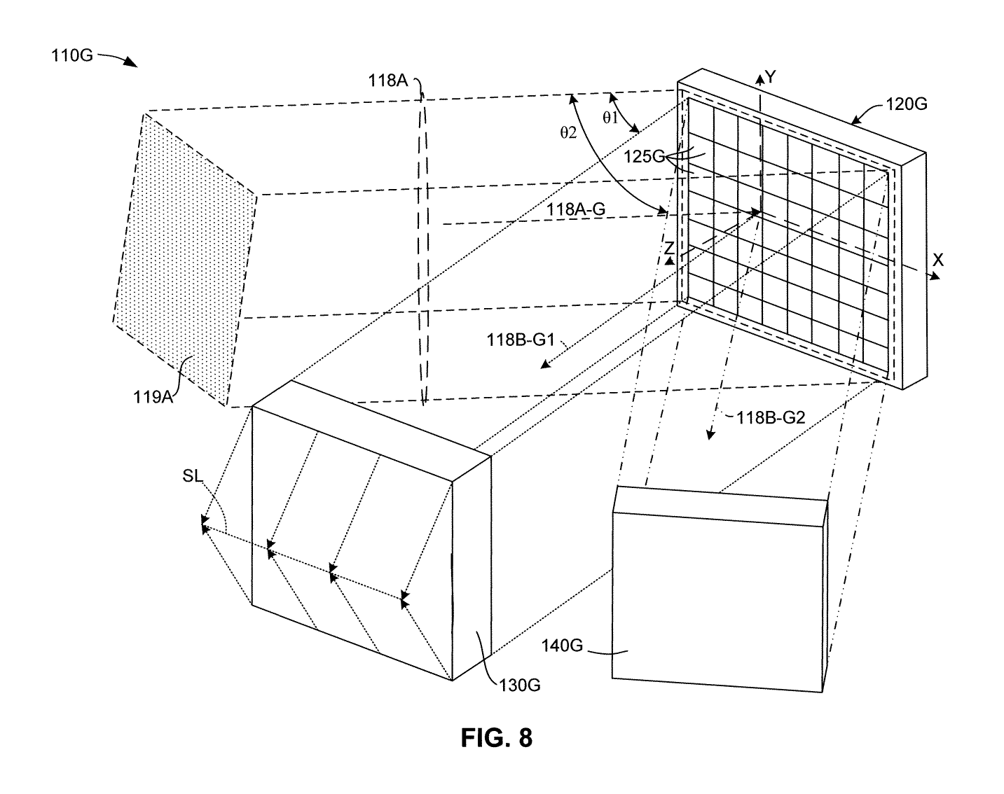

FIG. 8 is a simplified perspective view showing an imaging system 100G including DMD-type spatial light modulator 120G disposed in a preferred “folded” arrangement according to another embodiment of the present invention. Similar to the generalized system 100 discussed above with reference to FIG. 1, imaging system 100G includes a homogenous light generator 110G and an anamorphic optical system 130 that function and operate as described above. Imaging system 100G is distinguished from the generalized system in that spatial light modulator 120G is positioned relative to homogenous light generator 110G and anamorphic optical system 130 at a compound angle such that incident homogenous light portion 118A-G is neither parallel nor perpendicular to any of the orthogonal axes X, Y or Z defined by the surface of spatial light modulator 120G, and neither is reflected light portions 118B-G1 and 118B-G2 (respectively produced when the mirrors are in the “on” and “off” positions) With the components of imaging system 100G positioned in this “folded” arrangement, portions of homogenous light 118A-G directed to spatial light modulator 120G from homogenous light generator 110G are reflected from MEMs mirror mechanism 125G to anamorphic optical system 130 only when the mirrors of each MEMs mirror mechanism 125G is in the “on” position (e.g., as described above with reference to FIG. 7(A)). That is, as indicated in FIG. 8, each MEMs mirror mechanism 125G that is in the “on” position reflects an associated one of light portions 118B-G1 at angle θ1 relative to the incident light direction, whereby light portions 118B-G1 are directed by spatial light modulator 120G along corresponding predetermined directions to anamorphic optical system 130, which is positioned and arranged to focus light portions 118G onto scan line SL, where scan line SL is perpendicular to the Z-axis defined by the surface of spatial light modulator 120G. The compound angle θ1 between the input rays 118A to the output “on” rays directed towards the anamorphic system 130G (e.g., ray 118B-G1) is typically 22-24 degrees or twice the mirror rotation angle of the DMD chip. Conversely, each MEMs mirror mechanism 125G that is in the “off” position reflects an associated one of light portions 118B-G2 at angle θ2, whereby light portions 118B-G2 are directed by spatial light modulator 120G away from anamorphic optical system 130. The compound angle between the entrance and “off” rays, θ2 is usually approximately 48 degrees. According to an aspect of the preferred “folded” arrangement, imaging system 100G includes a heat sink structure 140G that is positioned to receive light portions 118B-G2 that are reflected by MEMs mirror mechanisms 125G in the “off” position. According to another aspect of the preferred “folded” arrangement using the compound incident angle design set forth above, the components of imaging system 100G are arranged in a manner that facilitates the construction of a seamless assembly including any number of identical imaging systems 100G.

In one embodiment, the components of the system shown in FIG. 8 are maintained in the “folded” arrangement by way of a rigid frame that is described in detail in co-pending application Ser. No. 13/216,817, entitled SINGLE-PASS IMAGING SYSTEM USING SPATIAL LIGHT MODULATOR AND ANAMORPHIC PROJECTION OPTICS, which is incorporated herein by reference in its entirety.

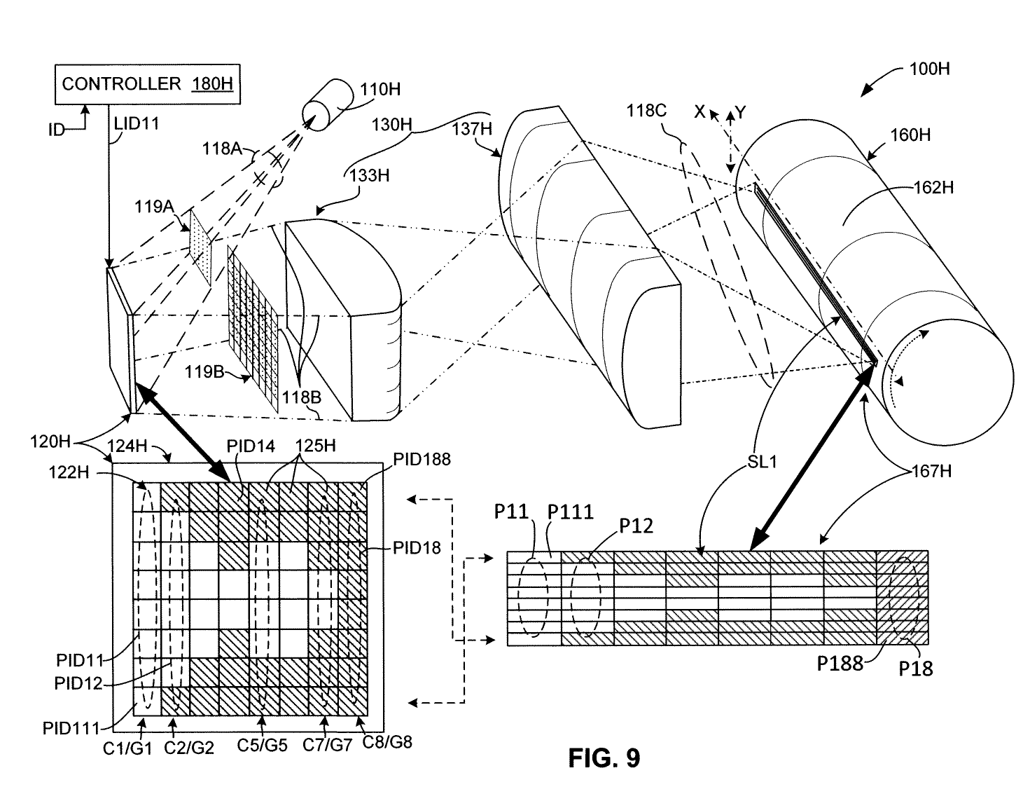

FIG. 9 is a perspective view showing another imaging system 100H utilizing a DMD-type spatial light modulator 120H in the folded arrangement of FIG. 8 according to another specific embodiment of the present invention. Imaging system 100H also includes a controller 180H that transmits scan line image data portions (e.g., portion LIN11) to DMD-type spatial light modulator 120H. Similar to the previous embodiment, spatial light modulator 120H includes sixty-four light modulating elements 125H disposed in an eight-by-eight array 122H on a substrate 124H, where light modulating elements 125H comprise the MEMs mirror mechanisms described above with reference to FIGS. 5-7. In addition, similar to the simplified embodiment of FIG. 8, homogenous light field 119A is directed onto light modulating elements 125H to produce a modulated light field 119B that is imaged and concentrated by a cross-process optical subsystem 133H and a process-direction optical subsystem 137H of an anamorphic optical system 130H onto an outer (imaging) surface 162H of a drum cylinder 160H.

DMD-type imaging system 100H differs from the previous embodiments in that anamorphic optical system 130H inverts modulated light field 119B in both the process and cross-process directions such that the position and left-to-right order of the two scan line images generated on drum cylinder 160H are effectively “flipped” in both the process and cross-process directions. The diagram at the lower left portion of FIG. 9 shows a front view of DMD-type spatial light modulator 120H, and the diagram at the lower right portion of FIG. 9 shows a front view of elongated imaging region 167H of imaging surface 162H. Similar to the embodiment described above with reference to FIG. 1, the lower left diagram shows that modulating element column C1 forms a first modulating element group G1 that is controlled by a first pixel image data portion PID11 of scan line image data portions LIN11. Similarly, the remaining light modulating element columns form corresponding modulating element groups that implement the remaining pixel image data portions of scan line image data portions LIN11 (e.g., column C4 forms group G4 that implements pixel image data portion PID14, and column C8 forms group G8 that implements pixel image data portion PID18. Note that modulating element groups G1-G8 are written into spatial light modulator 120H in an “upside-down and backward” manner such that pixel image data bit PID111 of pixel image data portion PID11 is written an inverted (upside-down) manner into a lowermost modulating element of modulating element group G1 (i.e., the lower left portion of array 122H when viewed from the front), and pixel image data bit PID188 of pixel image data portion PID18 is written in an inverted (upside-down) manner in the upper portion of modulating element group G8 (i.e., the upper right portion of array 122H when viewed from the front). As indicated by the double-dot-dash lines in FIG. 9, cross-process optical subsystem 133H inverts modulated light field 119A such that the light modulating elements configured by pixel image data PID11 generate pixel image P11 on the right side of elongated imaging region 167H, and the light modulating elements configured by pixel image data PID18 generate pixel image P18 on the upper left side of elongated imaging region 167H. In addition, process optical subsystem 137H inverts modulated light field 119A such that (non-inverted) pixel image portion (which is generated by the modulating element implementing pixel image data bit PID111) appears in the upper-left portion of elongated imaging region 167H, and such that (non-inverted) pixel image P188 (which is generated by the modulating element implementing pixel image data bit PID188) appears in the lower-right portion of elongated imaging region 167H.

Consistent with the aspects described above, multi-level image exposure is achieved using imaging system 100H by configuring groups of MEMs mirror mechanisms of DMD-type spatial light modulator 120H that are substantially aligned in the process (Y-axis) direction such that “partially on” pixel images are implemented by activating contiguous MEMs mirror mechanisms that are disposed in the central region of the associated MEMs mirror mechanism group. For example, in the exemplary embodiment shown in FIG. 9, modulating element group G1 consists of the modulating elements 125H disposed in column C1, where group G1 is configured in accordance with a first image pixel data portion PID11 such that all of the modulating elements are disposed an “on” modulated state (indicated by the white filling each element), whereby a pixel image P11 is generated on imaging surface 162H having a maximum brightness. Similarly, modulating element group G8 consists of the modulating elements 125H disposed in column 08, where group G8 is configured in accordance with an image pixel data portion PID18 such that all of the modulating elements are disposed an “off” modulated state (indicated by the slanted-line filling each element), whereby a dark pixel image P18 is generated on imaging surface 162H. The remaining groups (columns) of MEMs mirror mechanisms are configured using three exemplary “partially on” gray-scale values. For example, group G2 is configured by pixel image data portion PID12 having a “mostly on” gray-scale value such that two deactivated MEMs mirror mechanisms disposed at the top and bottom of column C2, and six activated MEMs mirror mechanisms disposed between the deactivated MEMs mirror mechanisms. In contrasts, group G7 is configured by a pixel image data portion having a “barely on” gray-scale value including six deactivated MEMs mirror mechanisms disposed at the top and bottom of column 07 and two activated MEMs mirror mechanisms disposed between the deactivated MEMs mirror mechanisms, and group G5 is configured by a pixel image data portion having a “medium on” gray-scale value including four deactivated MEMs mirror mechanisms disposed at the top and bottom of column C5 and four activated MEMs mirror mechanisms disposed between the deactivated MEMs mirror mechanisms.

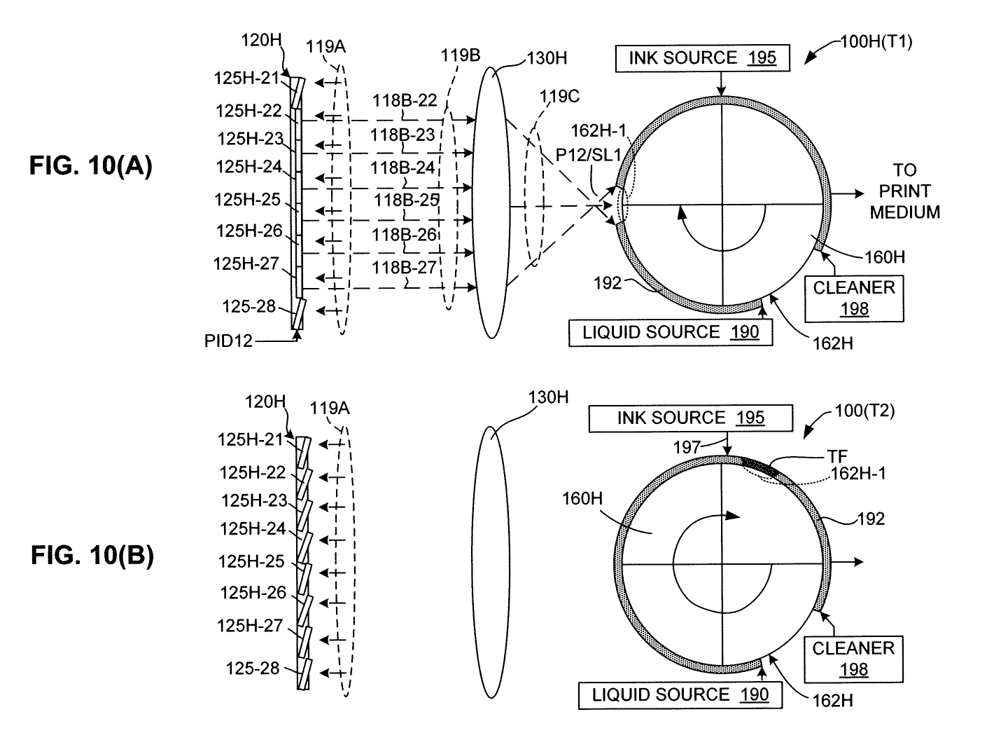

FIGS. 10(A), 10(B), 10(C) and 10(D) are simplified side views showing the imaging system 100H of FIG. 9 during an exemplary imaging operation. Note that the simplified side views ignore inversion in the process-direction, and as such anamorphic optical system 130H is depicted by a single cross-process lens.

FIG. 10(A) illustrates imaging system 100H(T1) (i.e., imaging system 100H during a first time period T1 of the imaging operation) when exemplary modulating element group G2 of spatial light modulator 120H is respectively configured in accordance with scan line image data group PID12 in the manner described above with reference to FIG. 9. In particular, FIG. 10(A) depicts the configuration of modulating elements 125H-21 to 125H-28 using pixel image data portion PID12 such that MEMs mirror mechanisms 125H-22 to 125H-27 are activated and MEMs mirror mechanisms 125H-21 and 125H-28 are deactivated.

Referring to the right side of FIG. 10(A), to implement an image transfer operation, imaging system 100H further includes a liquid source 190 that applies a fountain solution 192 onto imaging surface 162H at a point upstream of the imaging region, an ink source 195 that applies an ink material 197 at a point downstream of imaging region. In addition, a transfer mechanism (not shown) is provided for transferring the ink material 197 to a target print medium, and a cleaning mechanism 198 is provided for preparing imaging surface 162H for the next exposure cycle. The image transfer operation is further described below with reference to FIGS. 10(B) to 10(D).

Referring again to FIG. 10(A), because of their activated configuration state, MEMs mirror mechanisms (light modulating elements) 125H-22 to 125H-27 reflect portions of homogenous light field 119A such that modulated light portions 118B-21 to 118B-27 are directed through anamorphic optical system 130H (note that homogeneous light portions are redirected away from anamorphic optical system 130H by deactivated MEMs mirror mechanisms 125H-21 and 125H-28). Modulated light portions 118B-21 to 118B-27 form modulated light field 119B that is imaged and concentrated by anamorphic optical system 130H, thereby generating concentrated modulated light field 119C that produces pixel image P12, which forms part of a scan line image SL1 in an elongated surface region 162H-1 on imaging surface 162H. In particular, the concentrated light associated formed by modulated light portions 118B-21 to 118B-27 removes (evaporates) fountain solution 192 from the elongated surface region 162H-1 (i.e., such that surface region 162H-1 at pixel image P21 is exposed). Note that the size of pixel image P21 (i.e., the amount of fountain solution that is removed from imaging surface 162H) is determined by number of activated MEMs mirror mechanisms.

FIGS. 10(B), 10(C) and 10(D) show imaging system 100H at times subsequent to time Ti, where spatial light modulator 120H is deactivated in order to how surface feature P12 (see FIG. 10(A)) is subsequently utilized in accordance with the image transfer operation of imaging system 100H. Referring to FIG. 10(B), at a time T2 drum cylinder 160H has rotated such that surface region 162H-1 has passed under ink source 195. Due to the removal of fountain solution depicted in FIG. 10(A), ink material 197 adheres to exposed surface region 162H-1 to form an ink feature TF. Referring to FIG. 10(C), at a time T3 while ink feature TF is passing the transfer point, the weak adhesion between the ink material and surface region 162H-1 and the strong attraction of the ink material to the print medium (not shown) causes ink feature TF to transfer to the print medium, resulting in a “dot” in the ink printed on the print medium. At a subsequent T4, as indicated in FIG. 10(D), surface region 162H-1 is rotated under cleaning mechanism 198, which removes any residual ink and fountain solution material to prepare surface region 162H-1 for a subsequent exposure/print cycle. According to the above-described image transfer operation, ink material only transfers onto portions of imaging surface 162H that are exposed by the imaging process described above (i.e., ink material does not adhere to fountain solution 192), whereby ink material is only transferred to the print medium from portions of drum roller 160H that are subjected to concentrated light as described herein. Thus, variable data from fountain solution removal is transferred, instead of constant data from a plate as in conventional systems. For this process to work using a rastered light source (i.e., a light source that is rastered back and forth across the scan line), a single very high power light (e.g., laser) source would be required to sufficiently remove the fountain solution in real time. A benefit of the imaging operation of the present invention is that, because liquid is removed from the entire scan line simultaneously, an offset press configuration is provided at high speed using multiple relatively low power light sources.

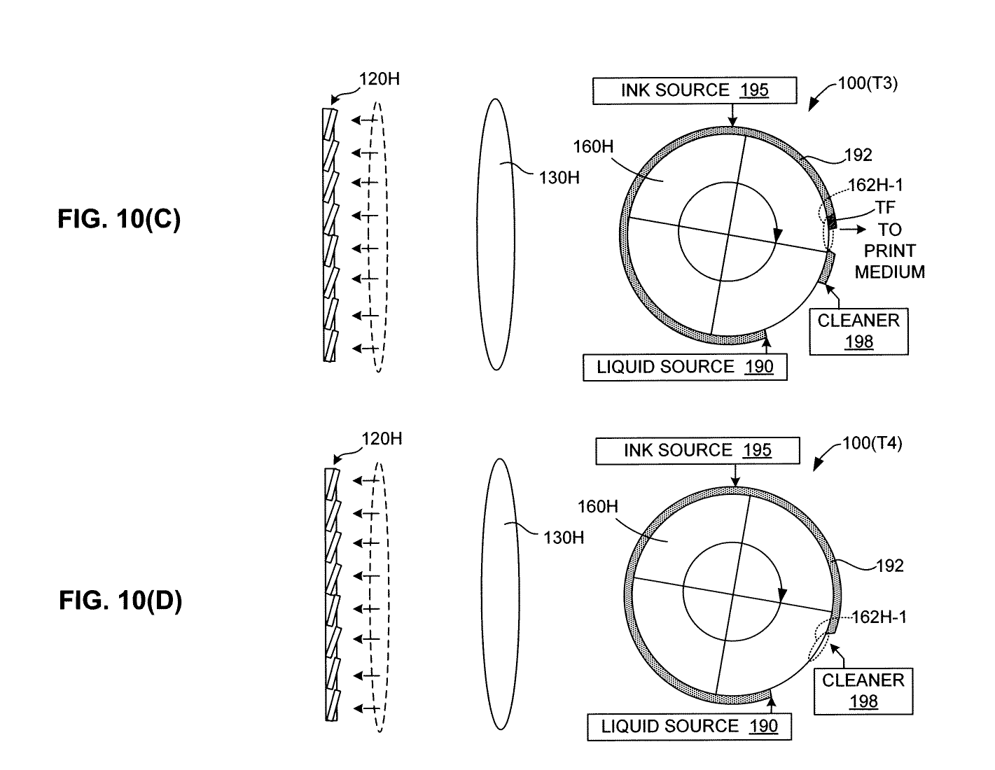

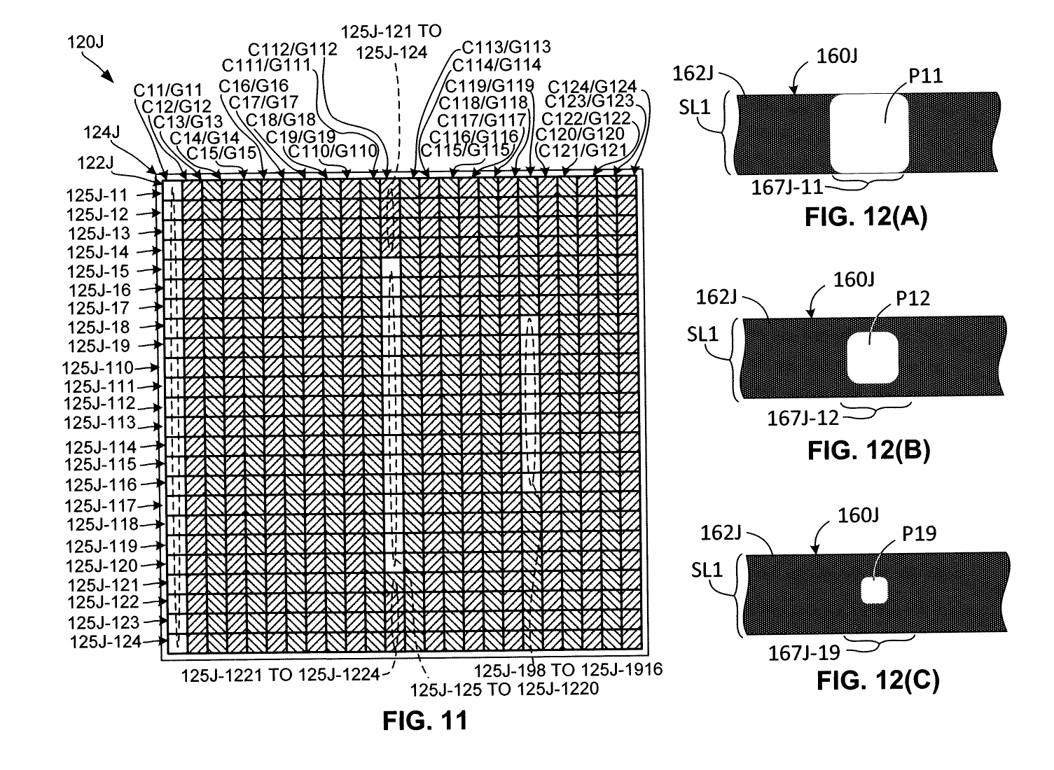

FIG. 11 is a simplified front view showing a DMD-type spatial light modulator 120J including a twenty-four-by-twenty-four array 122J of MEMs mirror mechanisms (light modulating elements) 125J that are disposed on a substrate 124J and configured to implement an imaging operation according to another embodiment of the present invention, and FIGS. 12(A)-12(C) are simplified front views showing portions of an imaging surface 162J of a drum cylinder 160J during a single imaging phase using spatial light modulator 120J. Other than the larger number of MEMs mirror mechanisms (light modulating elements) 125J provided on spatial light modulator 120J and the modified configuration discussed below, an imaging system including spatial light modulator 120J and drum cylinder 160J is essentially the same as imaging system described above with reference FIGS. 9 and 10(A)-10(D).

Consistent with the aspects described above, DMD-type spatial light modulator 120K includes twenty-four MEMs mirror mechanism groups G11 to G124 made up of MEMs mirror mechanisms that are substantially aligned in the process (Y-axis) direction. Note that the present example assumes that DMD-type spatial light modulator 120J is positioned orthogonally relative to an associated anamorphic optical system (not shown) such that columns C11 to C124 are aligned with the process direction of the associated anamorphic optical system. As such, for reasons explained above, each MEMs mirror mechanism group Gil to G124 respectively consists of all MEMs mirror mechanisms disposed in a corresponding column C11 to C124. For example, MEMs mirror mechanism group G11 consists of modulating elements 125J-11 to 125J-124 disposed in column C11, MEMs mirror mechanism group G12 consists of modulating elements disposed in column C12, etc.

In addition, consistent with the aspects described above, multi-level image exposure is achieved by configuring groups Gil to G124, where “partially on” pixel images are implemented by activating either one-third or two-thirds of the contiguous MEMs mirror mechanisms that are disposed in the central region of the associated MEMs mirror mechanism group. For example, referring to the left side of FIG. 11 and to FIG. 12(A), group G11 is configured to implement a “fully on” gray-scale value by activating all of MEMs mirror mechanisms 125J-11 to 125J-124, whereby a pixel image P11 of a corresponding scan line image SL1 is generated in a scanning region portion 167J-1 of imaging surface 162J that has a maximum pixel brightness. Similarly, modulating element group G124 consists of the modulating elements 125J disposed in column C124, where group G124 is configured in accordance with “fully off” gray-scale value such that all of the MEMs mirror mechanisms disposed in column C124 are deactivated (i.e., disposed an “off” modulated state), whereby a dark pixel image is generated. Groups G112 and G119 are respectively configured to implement “⅔ partially on” and “⅓ partially on” gray-scale values according to an aspect of the present embodiment. Group G112 implements the “⅔ partially on” gray-scale value by activating MEMs mirror mechanisms 125J-125 to 125J-1220 and deactivating MEMs mirror mechanisms 125J-121 to 125J-124 and 125J-1221 to 125J-1224, whereby two-thirds of the MEMs mirror mechanisms of group G112 located in the central region of column C112 are configured to generate a pixel image P12 (FIG. 12(B) of scan line image SL1 in a scanning region portion 167J-12 of imaging surface 162J having a brightness (size) that is approximately ⅔ of pixel image P11 (FIG. 12(A)). Similarly, group G119 implements the “⅓ partially on” gray-scale value by activating MEMs mirror mechanisms 125J-198 to 125J-1916 and deactivating the remaining MEMs mirror mechanisms in column C119, whereby one-thirds of the MEMs mirror mechanisms of group G119 located in the central region of column C119 are configured to generate a pixel image P19 (FIG. 12(C) of scan line image SL1 in a scanning region portion 167J-19 of imaging surface 162J, where pixel image P19 has a brightness (size) that is approximately ⅓ of pixel image P11 (FIG. 12(A)).

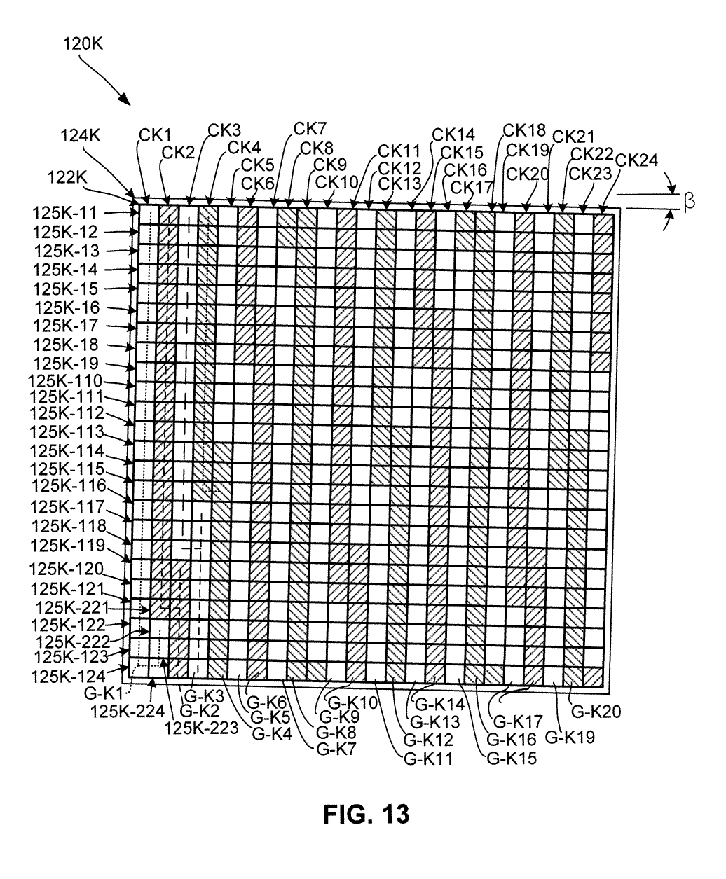

FIG. 13 is a simplified front view showing a DMD-type spatial light modulator 120K including a twenty-four-by-twenty-four array 122K of MEMs mirror mechanisms 125K that are disposed on a substrate 124K in a manner similar to that described above with reference to FIG. 11.

In accordance with an aspect of the embodiment shown in FIG. 13, spatial light modulator 120 is slightly rotated by a small angle relative to the process and cross-process orthogonal directions of an associated anamorphic optical system (not shown), whereby modulating elements 125K are aligned at a small acute tilt angle β (e.g., 1.8°) relative to the associated process direction. The benefit of this tilted orientation is that imaging system produces a higher sub-pixel spatial addressable spacing and provides an opportunity to utilize software to position the pixel images with fractional precision in both the cross-process (X-axis) and process (Y-axis) directions.

In accordance with another aspect of the embodiment shown in FIG. 13, in order to provide MEMs mirror mechanism groups that are aligned in the process direction, spatial light modulator 120K includes MEMs mirror mechanism groups G-K1 to G-K20 that include MEMs mirror mechanisms 125K disposed in two adjacent columns. For example, MEMs mirror mechanism group G-K1 includes both MEMs mirror mechanisms 125K-11 to 125K-124 of column CK1 and MEMs mirror mechanisms 125K-222 to 125K-224 of column CK2, which are generally aligned in the process direction. Similarly, group G-K2 includes both MEMs mirror mechanisms 125K-21 to 125K-221 of column CK2 and five MEMs mirror mechanisms disposed at the bottom of column CK3. Note that the MEMs mirror mechanisms associated in respective groups G-K1 to G-K20 are indicated by alternating shaded and unshaded boxes. By implementing spatial light modulator 120K with the tilt arrangement and configuring the respective MEMs mirror mechanism groups G-K1 to G-K20 according to the multi-level image exposure methods described above, spatial light modulator 120K facilitates the formation of an imaging system that provides both the higher sub-pixel spacing associated with the tilt arrangement and the superior pixel image generation provided by the multi-level image exposure methods.

Although the present invention has been described with respect to certain specific embodiments, it will be clear to those skilled in the art that the inventive features of the present invention are applicable to other embodiments as well, all of which are intended to fall within the scope of the present invention. For example, although the present invention is illustrated as having light paths that are linear (see FIG. 1) or with having one fold (see FIG. 8), other arrangements may be contemplated by those skilled in the art that include folding along any number of arbitrary light paths. Finally, the methods described above for generating a high energy scan line image may be achieved using devices other than those described herein.

1. A method for generating scan line image on an imaging surface in response to scan line image data including a plurality of pixel image data portions, the method comprising:
configuring a spatial light modulator in accordance with said scan line image data, said spatial light modulator including a plurality of light modulating elements arranged in an array having a plurality of rows and a plurality of columns; and
utilizing the spatial light modulator to generate a first substantially one-dimensional scan line image on said imaging surface by directing homogenous light onto the spatial light modulator such that the plurality of configured light modulating elements generate a modulated light field that is transmitted through an anamorphic optical system onto said imaging surface, wherein the anamorphic optical system is formed and positioned such that said modulated light field is anamorphically imaged and concentrated in a process direction, and such that said substantially one-dimensional scan line image extends in a cross-process direction on said imaging surface,
wherein configuring said spatial light modulator includes adjusting an associated modulating element group of said plurality of light modulating elements in accordance with each associated pixel image data portion of said scan line image data group, where each said associated modulating element group includes an associated plurality of said light modulating elements that are substantially aligned in the process direction.

2. The method according to claim 1, wherein adjusting each said associated modulating element group comprises:
when said associated pixel image data portion has a first value, configuring all of the modulating elements of said associated modulating element group into a first modulated state such that homogeneous light portions directed onto all of said modulating elements are directed from all of said modulating elements to said anamorphic optical system,
when said associated pixel image data portion has a second value, configuring all of the modulating elements of said associated modulating element group into a second modulated state such that homogeneous light portions directed onto all of said modulating elements are prevented from reaching said anamorphic optical system, and
when said associated pixel image data portion has a third value, configuring a first portion of the modulating elements of said associated modulating element group into said first modulated state and configuring a second portion of the modulating elements of said associated modulating element group into said second modulated state, whereby only homogeneous light portions directed onto said first portion of said modulating elements are directed to said anamorphic optical system.

3. The method according to claim 1, wherein adjusting said associated modulating element group comprises configuring multiple modulating elements disposed in a single column of said plurality of columns of said array.

4. The method according to claim 3, wherein when said associated pixel image data portion has said third value, configuring said first portion of the modulating elements of said associated modulating element group comprises configuring two or more first modulating elements disposed in a center of said single column into said first modulated state, and configuring said second portion of the modulating elements of said associated modulating element group comprises configuring at least one second modulating element disposed above said two or more first modulating elements in said single column into said second modulated state, and configuring at least one third modulating element disposed below said two or more first modulating elements in said single column into said second modulated state.

5. The method according to claim 4, wherein configuring said first portion of the modulating elements of said associated modulating element group comprises configuring approximately one-third of the total number of modulating elements disposed in said single column.

6. The method according to claim 4, wherein configuring said first portion of the modulating elements of said associated modulating element group comprises configuring approximately two-thirds of the total number of modulating elements disposed in said single column.

7. The method according to claim 1, wherein directing said homogenous light onto the plurality of light modulating elements comprises causing a laser light source to transmit one or more light beams having a first flux density through a homogenizer such that the homogenous light is emitted from the homogenizer and directed onto the plurality of light modulating elements.

8. The method of claim 1, wherein configuring said spatial light modulator includes individually adjusting, in response to a value stored in an associated memory cell, each modulating element of said plurality of modulating elements in said each modulating element group into one of said first modulated state and said second modulated state, wherein said plurality of light modulating elements are arranged such that when said each modulating element is in said first modulated state, said each modulating element modulates an associated received homogenous light portion of said homogenous light such that an associated modulated light portion is directed toward the anamorphic optical system, and when said each modulating element is in said second modulated state, said each modulating element modulates the associated received homogenous light portion such that the associated modulated light portion is directed away from said anamorphic optical system.

9. The method according to claim 1, wherein directing homogenous light further comprises:
projecting and magnifying said modulated light field in a process direction using first and second focusing lens, and
concentrating said modulated light field in a direction parallel to a cross-process direction using a third focusing lens.

10. The method according to claim 1, wherein configuring said spatial light modulator comprises configuring one of a digital micromirror device, an electro-optic diffractive modulator array, and an array of thermo-optic absorber elements.

11. The method according to claim 1, wherein configuring said spatial light modulator comprises configuring a plurality of microelectromechanical (MEMs) mirror mechanisms disposed on a substrate by individually controlling the MEMs mirror mechanisms such that a mirror of each said MEM mirror mechanism is moved between a first tilted position relative to the substrate, and a second tilted position relative to the substrate in accordance with said associated pixel image data portion.

12. The method according to claim 11, wherein configuring said spatial light modulator further comprises positioning the spatial light modulator such that, when the mirror of each said MEMs mirror mechanism is in the first tilted position, said mirror reflects an associated portion homogenous light portion of said homogenous light such that said reflected light portion is directed toward said anamorphic optical system, and when said mirror of each said MEMs mirror mechanism is in the second tilted position, said mirror reflects said associated received homogenous light portion such that said reflected light portion is directed away from the anamorphic optical system.

13. The method according to claim 12, wherein adjusting each said associated modulating element group comprises:
when said associated pixel image data portion has a first value, moving the mirrors of all of the MEMs mirror mechanisms of said associated modulating element group into the first tilted position such that homogeneous light portions directed onto all of said MEMs mirror mechanisms are directed toward said anamorphic optical system,
when said associated pixel image data portion has a second value, moving the mirrors of all of the MEMs mirror mechanisms of said associated modulating element group into the second tilted position such that such that homogeneous light portions directed onto all of said MEMs mirror mechanisms are directed away from said anamorphic optical system, and
when said associated pixel image data portion has a third value, moving the mirrors of a first portion of the MEMs mirror mechanisms of said associated modulating element group into said first tilted position and configuring a second portion of the MEMs mirror mechanisms of said associated modulating element group into said second tilted position, whereby only homogeneous light portions directed onto the mirrors of said first portion of said MEMs mirror mechanisms are directed toward said anamorphic optical system.

14. The method according to claim 13, wherein adjusting said associated modulating element group comprises moving the mirrors of all said MEMs mirror mechanisms disposed in a single column of said array.

15. The method according to claim 14, wherein when said associated pixel image data portion has said third value, configuring said first portion of the MEMs mirror mechanisms of said associated modulating element group comprises moving the mirrors of two or more first MEMs mirror mechanisms disposed in a center of said single column into said first tilted position, and configuring said second portion of the MEMs mirror mechanisms of said associated modulating element group comprises moving the mirrors of two or more second MEMs mirror mechanisms in said single column into said second tilted position, where at least one of said second MEMs mirror mechanisms is disposed above said first MEMs mirror mechanisms in said single column, and at least one of said second MEMs mirror mechanisms is disposed below said first MEMs mirror mechanisms.

16. The method according to claim 15, wherein configuring said first portion of the MEMs mirror mechanisms of said associated modulating element group comprises configuring approximately one-third of the total number of MEMs mirror mechanisms disposed in said single column.

17. The method according to claim 15, wherein configuring said first portion of the MEMs mirror mechanisms of said associated modulating element group comprises configuring approximately two-thirds of the total number of MEMs mirror mechanisms disposed in said single column.

18. The method according to claim 13, wherein adjusting said associated modulating element group comprises moving the mirrors of a first group of said MEMs mirror mechanisms disposed in a first column of said array, and moving the mirrors of a second group of said MEMs mirror mechanisms disposed in a second column of said array.

19. A single-pass imaging system for generating scan line image on an imaging surface in response to scan line image data including a plurality of pixel image data portions, comprising:
a homogenous light generator for generating homogenous light such that the homogenous light forms a substantially uniform homogenous light field;
a spatial light modulator including a plurality of light modulating elements arranged in a two-dimensional array and disposed in the homogenous light field such that each said modulating element receives an associated homogenous light portion of the homogenous light, wherein each modulating element is individually adjustable between a first modulated state and a second modulated state, whereby when said each modulating element is in said first modulated state, said each modulating element modulates an associated received homogenous light portion such that an associated modulated light portion is directed in a corresponding predetermined direction, and when said each modulating element is in said second modulated state, said each modulating element modulates the associated received homogenous light portion such that the associated modulated light portion is prevented from passing along said corresponding predetermined direction;
an anamorphic optical system positioned to receive said modulated light portions from said each modulating element disposed in said first modulated state, and arranged to concentrate said modulated light portions such that the concentrated modulated light portions produce an elongated scan line image that is aligned in a cross-process direction; and
means for configuring the spatial light modulator such that each modulating element of an associated group of said plurality of light modulating elements is adjusted in accordance with each associated pixel image data portion of said scan line image data group, wherein each said associated modulating element group includes an associated plurality of said light modulating elements that are substantially aligned in the process direction.

20. The single-pass imaging system according to claim 1, wherein said means comprises means for adjusting each said associated modulating element group such that:
when said associated pixel image data portion has a first value, configuring all of the modulating elements of said associated modulating element group into a first modulated state such that homogeneous light portions directed onto all of said modulating elements are directed from all of said modulating elements to said anamorphic optical system,
when said associated pixel image data portion has a second value, configuring all of the modulating elements of said associated modulating element group into a second modulated state such that homogeneous light portions directed onto all of said modulating elements are prevented from reaching said anamorphic optical system, and
when said associated pixel image data portion has a third value, configuring a first portion of the modulating elements of said associated modulating element group into said first modulated state and configuring a second portion of the modulating elements of said associated modulating element group into said second modulated state, whereby only homogeneous light portions directed onto said first portion of said modulating elements are directed to said anamorphic optical system.
